(19) United States
(12) Patent Application Publication
(10) Pub. No.: US 2013/0152048 A1
(43) Pub. Date: Jun. 13, 2013

(54) TEST METHOD, PROCESSING DEVICE, TEST PROGRAM GENERATION METHOD AND TEST PROGRAM GENERATOR

(71) Applicant: Fujitsu Limited, Kawasaki-shi (JP)

(72) Inventors: Hiromi SATO, Kawasaki (JP); Fumio ICHIKAWA, Sagamihara (JP)

(73) Assignee: FUJITSU LIMITED, Kawasaki-shi (JP)

(21) Appl. No.: 13/764,069

(22) Filed: Feb. 11, 2013

Related U.S. Application Data
(63) Continuation of application No. PCT/JP2010/063935, filed on Aug. 18, 2010.

(51) Int. Cl. G06F 11/36

(52) U.S. Cl. CPC G06F 11/3692; G06F 11/3684
USPC 717/124; 717/126

(57) ABSTRACT

A test method includes reading out, by a processor, a branch instruction from a storage unit that stores instructions, referring to a branch destination address of the branch instruction in a branch history unit that stores a branch history which links an address of the branch instruction and a branch destination address, reading out first random number data unconstrained by test protocols as the succeeding instruction of the branch instruction from the storage unit when the branch history of the branch instruction is not in the branch history unit, calculating the branch destination address of the branch instruction and executing the first random number data, and invalidating the result of execution of the first random number data when the calculated branch destination address and the address of the random number data differ.

### CROSS-REFERENCE TO RELATED APPLICATIONS

This application is a continuation application of International Application PCT/JP 2010/63935 filed on Aug. 18, 2010 and designated the U.S., the entire contents of which are incorporated herein by reference.

### FIELD

The embodiments discussed herein relate to a test method, processing device, test program generation method and test program generator.

### BACKGROUND

As a test method of a processing device, there is the method of causing the processing system under test to run a test program and of determining validity of the results of execution of the test program. The validity of the results of execution is determined by, for example, comparing the results of the test program executed by the computer system and expected values of the test program. The tests include, for example, a logic simulation test which confirms if the logic circuits of the designed processing system are designed as in the design specifications and an actual operating test which confirms if the processing system of the actual manufactured machine operates as in the operation specifications.

Japanese Laid-Open Patent Publication No. 2002-312164

### SUMMARY

According to an aspect of the embodiment, a test method includes reading out, by a processor, a branch instruction from a storage unit that stores instructions, referring to a branch destination address of the branch instruction in a branch history unit that stores a branch history which links an address of the branch instruction and a branch destination address, reading out first random number data unconstrained by test protocols as the succeeding instruction of the branch instruction from the storage unit when the branch history of the branch instruction is not in the branch history unit, calculating the branch destination address of the branch instruction and executing the first random number data, and invalidating the result of execution of the first random number data when the calculated branch destination address and the address of the random number data differ.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view which illustrates one example of a memory access instruction complying with test protocols.

FIG. 2 is a view which illustrates one example of an operation instruction complying with test protocols.

FIG. 3 is a view which illustrates one example of a branch instruction complying with test protocols.

FIG. 4 is a view which illustrates one example of an operation for speculative execution of random number data by a processing system.

FIG. 5 is a view which illustrates one example of an information processing system.

FIG. 6 is a view which illustrates one example of a processing unit.

FIG. 7 is a view which illustrates one example of a branch history unit.

FIG. 8 is a view which illustrates one example of an instruction readout unit and instruction execution unit.

FIG. 9 is a view which illustrates one example of a main storage device.

FIG. 10A is a view which illustrates one example of an instruction conversion table.

FIG. 10B is a view which illustrates one example of AND/OR data which is used for generation of a random instruction or random number instruction of a branch instruction.

FIG. 10C is a view which illustrates one example of AND/OR data which is used for generation of a random instruction or random number instruction of a memory access instruction.

FIG. 10D is a view which illustrates one example of AND/OR data which is used for generation of a random instruction or random number instruction of an addition instruction.

FIG. 11 is a view which illustrates one example of a parameter table.

FIG. 12 is a view which illustrates one example of a test program generator and test controller.

FIG. 13 is a view which illustrates one example of a main storage device of a processing system.

FIG. 14 is a view which illustrates one example of a test instruction complying with test protocols.

FIG. 15 is a view which illustrates one example of a test instruction complying with test protocols.

FIG. 16 is a view which illustrates one example of a test instruction complying with test protocols.

FIG. 17 is a view which illustrates one example of the flow of generation of a random number instruction.

FIG. 18 is a view which illustrates one example of a branch instruction.

FIG. 19 is a view which illustrates one example of an instruction generation method of a branch instruction.

FIG. 20 is a view which illustrates one example of a memory access instruction.

FIG. 21A is a view which illustrates a first example of a sequence of execution of instructions of a test program.

FIG. 21B is a view which illustrates a first example of processing of a processing system which executes a test program.

FIG. 22 is a view which illustrates one example of a processing system which operates by execution of a test program.

FIG. 23A is a view which illustrates a second example of a sequence of execution of instructions of a test program.

FIG. 23B is a view which illustrates a second example of processing of a processing system which executes a test program.

FIG. 24A is a view which illustrates a third example of a sequence of execution of instructions of a test program.

FIG. 24B is a view which illustrates a third example of processing of a processing system which executes a test program.

FIG. 25A is a view which illustrates a fourth example of the sequence of execution of instructions of a test program.

FIG. 25B is a view which illustrates a fourth example of processing of a processing system which executes a test program.

FIG. 26 is a view which illustrates one modification of the number of instructions of the random number data.

FIG. 27 is a view which illustrates one example of an instruction string which includes a branch taken instruction.

FIG. 28 is a view which illustrates one example of an instruction string which includes a branch not-taken instruction.

FIG. 29A is a view which illustrates one example of processing for generation of a test program.

FIG. 29B is a view which illustrates one example of processing for generation of a test program.

FIG. 30 is a view which illustrates one example of processing for execution of a test program.

FIG. 31 is a view which illustrates one example of processing for generation of a test program.

### DESCRIPTION OF EMBODIMENTS

Below, referring to the drawings, a test method, processing device, test program, test program generation method, test programgenerator, and test program generation program will be explained.

[1] Limitations on Test by Test Protocols

First, the limitations on a test by test protocols will be explained with reference to the examples in [1.1] memory access instruction, [1.2] operation instruction, and [1.3] branch instruction. Note that, the test program which is illustrated below will be explained, for illustration sake, using the instruction set defined in the SPARC (Scalable Processor ARChitecture)® V9 (Version 9) instruction specifications.

[1.1] Memory Access Instruction

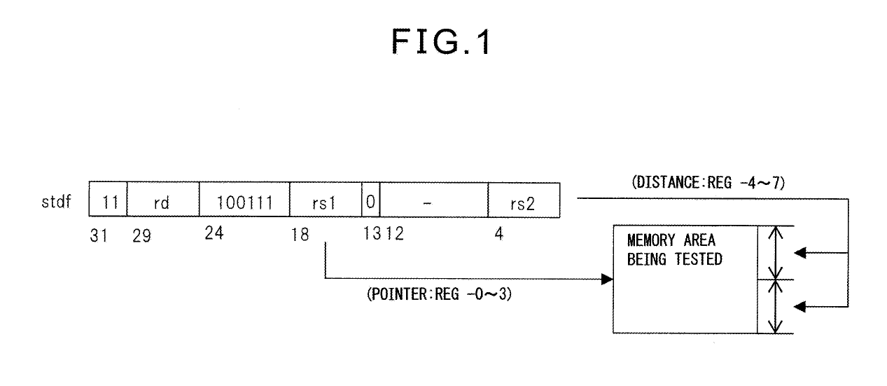

FIG. 1 is a view which illustrates one example of a memory access instruction complying with test protocols. The memory access instruction which is illustrated in FIG. 1 is a store double floating-point instruction (STDF).

The memory access instruction complying with test protocols and the memory area which stores by the memory access instruction are generated so as not to deviate from the memory space being tested. REG0 to 7 memory access registers which designate the memory space being tested are defined from the general use registers. A memory access instruction which selects the registers for memory access is generated defined by the pointer address of the “rs (resister source) 1” and the value of the distance of “rs2”. That is, by defining in advance the registers which designate the memory space being tested and setting the defined registers as the registers (rs1, rs2) for the memory access instruction at the time of generation of an instruction, it is possible to exclude generation of a memory access instruction deviating from the memory space being tested. Therefore, by defining the memory access registers, there is no longer memory access outside the memory space being tested, but only specific registers are used for memory access and it is not possible to cover all bit patterns at rs1 and rs2 at the memory access instruction of the test instruction.

[1.2] Operation Instruction

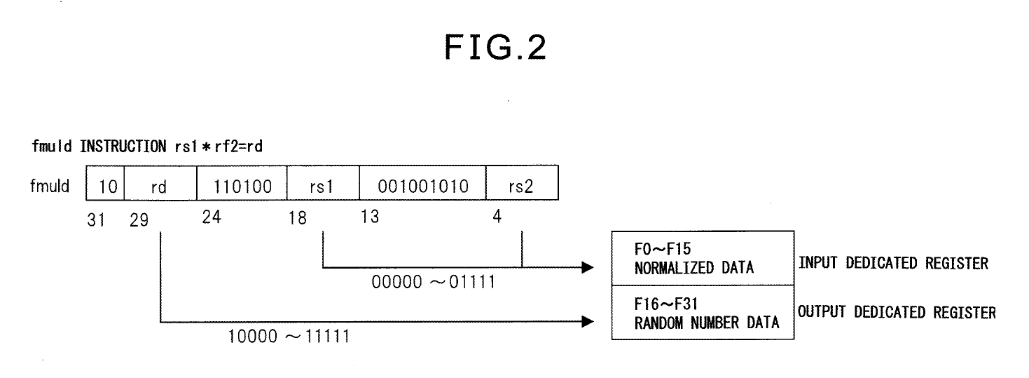

FIG. 2 is a view which illustrates one example of an operation instruction complying with test protocols. The operation instruction which is illustrated in FIG. 2 is a Floating-point MULtiply and Divide instruction (FMULD).

For the source registers of an operation instruction complying with test protocols, input dedicated registers are used so as not to cause operation exceptions. Operation exceptions include, for example, the overflow exception of the IEEE (The Institute of Electrical and Electronics Engineers, Inc.) 754. For example, when the test protocols stipulate that no floating point operation exception interrupt be allowed, for input of an operation instruction, only registers which have normalized data not causing operation exceptions can be selected. Further, registers which store results of an operation change in data each time repeating the operation and finally may become data which can causing floating point operation exception interrupts, so registers which store the results of an operation also cannot be used for input registers for an operation instruction. A floating point operation instruction is input to input dedicated registers and is restricted to registers in which normalized data is stored. Therefore, as illustrated in FIG. 2, input dedicated registers and output dedicated registers are defined, so, for example, the operation inputs “rs1” and “rs2” have the highest bits always at 0 and not able to be set to 1. Similarly, the operation output rd has the highest bit fixed to 1 and unable to be set to 0.

[1.3] Branch Instruction

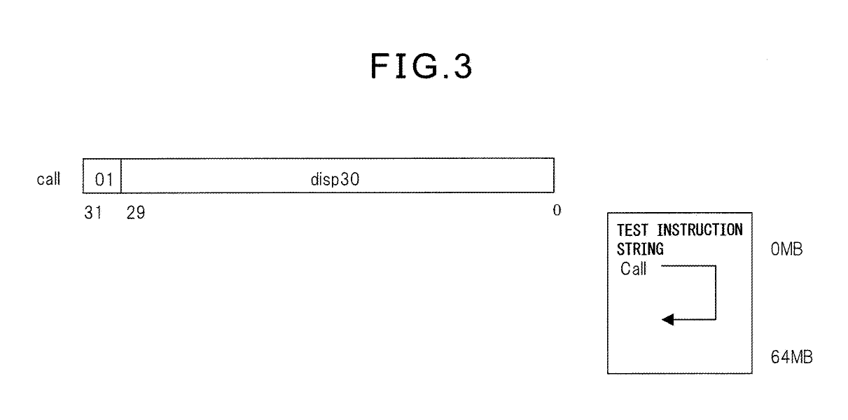

FIG. 3 is a view which illustrates one example of a branch instruction complying with test protocols. The test instruction which is illustrated in FIG. 3 is a relative branch instruction, that is, a CALL instruction.

A branch instruction complying with test protocols is generated so that the branch destination of the branch instruction does not exceed the test memory space in order to guarantee normal operation. A CALL instruction may be branched at an address as much as ±2 gigabytes away (designated by disp30), but it is impractical to prepare a test instruction space of over 4 gigabytes so as to cover all bit patterns of relative branches. For example, in the case of the maximum branching in a 64 MB instruction space, up to 24 bits of disp30 are used. The CALL instruction is generated so that 1 does not stand at the bits beyond this.

As explained above, to verify the appropriateness of the results of test execution, test instructions are generated in accordance with test protocols. However, with execution of test instructions complying with test protocols, it is difficult to verify the operation when the processing system actually executes instructions. Therefore, in the test method according to one embodiment, as illustrated below, the operation of the processing system unconstrained bytest protocols is tested by speculative execution of random number data, that is, test instructions not complying with test protocols.

Below, [2] Speculative execution of random number data not complying with test protocols will be explained.

[2] Speculative Execution of Random Number Data not Complying with Test Protocols

A test program includes a branch instruction and, after the branch instruction, random number data unconstrained by test protocols. The processing system speculatively executes the random number data unconstrainedlimited by test protocols until right before memory access, confirms branching, then invalidates the results of execution of the speculative execution so as to therefore test speculative execution operation unconstrained by test protocols.

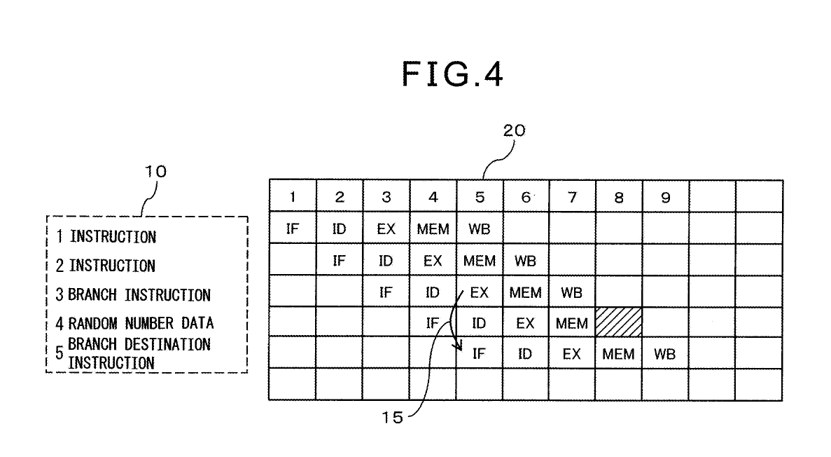

FIG. 4 is a view which illustrates one example of a speculative execution operation of random number data not complying with test protocols by the processing system. Reference numeral 10 is an example of the test program, while 20 is a time chart which illustrates pipeline processing by the processing system at the time of execution of the test program 10. Pipeline processing, for example, is processing which divides a single instruction into stages of instruction fetch (IF), instruction decode (RF), instruction execute (EX), operand fetch (MEM), and writeback (WB) and executes these so as to execute a plurality of instructions in parallel.

The instruction fetch stage fetches an instruction from the instruction cache. The instruction decode stage decodes the fetched instruction. The instruction execution stage executes the instruction based on the decoded results and the values of the registers fetched. For example, when executing a branch instruction, the branch destination address is calculated. The operand fetch stage loads the data which corresponds to the address calculated at the instruction execution stage from the data cache. The writeback stage stores the results of calculation at the instruction execution stage or the operands which were fetched at the operand fetch stage in the registers. In the case of a store operation, it writes them in the data cache.

The instructions at the addresses 1, 2, and 5 of the test program 10 are instructions complying with test protocols. The branch instruction at the address 3 is a branch instruction which causes the succeeding instruction, that is, random number data, to be speculatively executed and causes failure in branch prediction. The random number data at the address 4 is random number data not complying with test protocols. Note that, the “test protocols” are protocols which are determined in advance so as to clarify the verification of points for improvement in the processing system after test execution. For example, the test protocols include (1) nonoccurrence of operation exceptions, (2) limitations on designation of input/output registers, and (3) limitations on the storage area under test in the main memory. Details of the test protocols will be explained later in “[2] random number data not complying with test protocols”.

The processing system, when executing instructions 1 and 2, executes an instruction fetch stage to a writeback stage. The instructions 1 and 2 are data complying with test protocols, so writeback is used for storage in the storage area under test in the main memory.

When executing a branch instruction at an address 3 of the test program 10, the branch destination address of the branch instruction is definitively decided at the instruction execution stage after two cycles, so to avoid stalling, the random number data which is at the address 4 is predicted as the branch destination instruction and is speculatively executed. When the processing system calculates the branch destination address of the branch instruction at the instruction execution stage, the branch destination address is definitively determined to be the address 5, so, as shown by the arrow 15, the branch destination instruction at the branch destination address of the address 5 is executed.

On the other hand, the speculatively executed random number data failed in prediction, so as displayed by hatching, the processing system invalidates the results of execution without writeback storing the results of execution of the random number data in the memory.

Since random number data unconstrained limited by test protocols is speculatively executed as a succeeding instruction of the branch instruction up until right before memory access and the results of execution of the speculative execution are invalidated after definitive determination of branching, the test program 10 can be executed while testing operations unconstrained by test protocols by speculative execution.

Below, [3] an information processing system, [4 ]a processing unit which executes a test program, [5] generation of random number data unconstrained by test protocols, [6] operation for execution of a test program including random number data not complying with test protocols, [7] an instruction string including random number data not complying with test protocols, [8] the flow of processing for generating a test program, and [9] the flow of processing for executing a test program will be explained in that order.

[3] Information Processing System

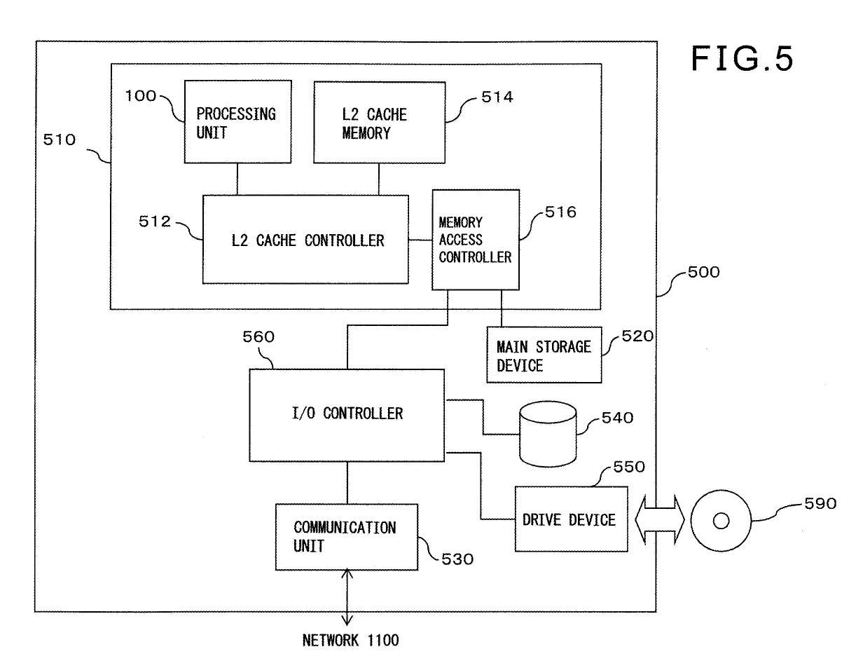

FIG. 5 is a view which illustrates one example of an information processing system. As illustrated in FIG. 5, the information processing system 500 has a processing device 510, main storage device or main memory 520, communication unit 530, external storage device 540, drive device 550, and I/O controller 560.

As illustrated in FIG. 5, the processing device 510 has a processing unit 100, L2 cache controller 512, L2 cache memory 514, and memory access control unit 516. Further, the processing device 510 is connected through an I/O controller 560 to the communication unit 530, external storage device 540, and drive device 550.

The processing device 510 is a system which executes a program which is stored in the main storage device 520 so as to thereby load data from the main storage device 520, processes the loaded data, and stores the results of the operation in the main storage device 520. The processing device 510 is, for example, a CPU (central processing unit).

The memory access control unit 516 is a unit which loads data from the main storage device 520 to the L2 cache memory 514, stores data from the L2 cache controller 512 to the main storage device 520.

The L2 cache memory 514 holds part of the data which the main storage device 520 stores. Further, the L2 cache memory 514 includes data which the L1 cache memory 110 of the processing unit 100 has holds.

The L2 cache controller 512 operates to store data with a high frequency of access from the processing unit 100 in the L2 cache memory 514 and to move data with a low frequency of access from the L2 cache memory 514 to the main storage device 520.

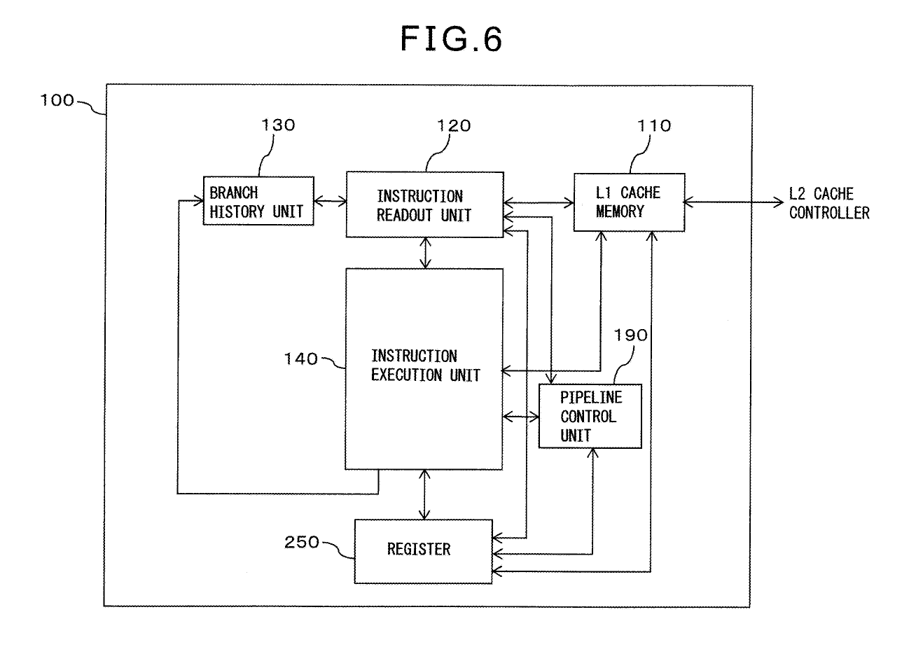

The processing unit 100 is, for example, a processor core and has the processing functions of the above processing device 510. Details of the processing unit 100 will be explained later while using FIG. 6 to FIG. 8. Note that, the number of the processing units which is illustrated in FIG. 5 is one, but not limited to one. When the processing device 510 has a plurality of processing units, a single processing unit operates as the master to execute the test program and operates to divide the test program for execution by the slaved other processing units. Such a master operation may be described as an instruction string in the test program and realized by execution of that instruction string.

The I/O controller 560 is an input/output control device which controls the connection of the processing device 510 with other units. The I/O controller 560 operates, for example, in accordance with the PCI Express (peripheral component interconnect express) standards.

The main storage device 520 is a device which stores data and programs. The processing device 510 can access the main storage device 520 without going through the I/O controller 560. The main storage device 520 is, for example, a DRAM (dynamic random access memory).

The external storage device 540 is a nonvolatile storage device which stores the programs and data which are stored in the main storage device 520. The external storage device 540 is a disk drive which uses a magnetic disk, an SSD (solid state drive) which uses a flash memory.

The communication unit 530 connects with a communication route provided by the network 1100 and transfers data between other information processing systems which are connected to the network 1100 and the information processing system 500. The communication device 530 is, for example, an NIC (network interface controller).

The drive device 550 is, for example, a device which reads and writes from and to a floppy® disk or CD-ROM (compact disc read only memory), DVD (digital versatile disc), or other storage medium 590. The drive device 550 includes a motor which turns the storage medium 590, a head which reads and writes with respect to the storage medium 590. Note that, the storage medium 590 may store programs. For example, the storage medium 590 may store the later explained test program generation program 910 and test program 920. The drive device 550 reads out programs from the storage medium 590 which is set in the drive device 550. The processing device 510 stores a program which is read out from the drive device 550 in the main storage device 520 or the secondary storage device 540.

[4] Processing Unit

Next, referring to FIG. 6 to FIG. 8, the processing unit 100 will be explained. FIG. 6 is a view which illustrates one example of a processing unit. As illustrated in FIG. 6, the processing unit 100 has an L1 cache memory 110, instruction readout unit 120, branch history unit 130, instruction execution unit 140, pipeline control unit 190, and register 250.

The L1 cache memory 110 is a storage device which stores instructions or data. The L1 cache memory 110 stores part of the data which the main storage device 520 stores. The L1 cache memory 110 is provided at the inside of the processing unit 100 and is at a position closer to the processing unit 100 than the main storage device 520. When the processing unit 100 accesses data which is stored in the L1 cache memory 110 (below, referred to as “cache hit”), the processing unit 100 may access the data covered in a short time. On the other hand, when the processing unit 100 accesses data which is not stored in the cache memory (below, referred to as “cache miss”), it reads out the data from the L2 cache memory 514 at a level below the L1 cache memory 110 or from the main storage device 520, so the time for accessing the data concerned becomes longer. For this reason, to prevent cache misses, instructions or data which are accessed from the processing unit 100 with a high frequency are stored in the L1 cache memory 110.

The L1 cache memory 110 is, for example, an SRAM (static random access memory).

The branch history unit 130 receives, as a history of execution of a branch instruction from the instruction execution unit 140, the address of the branch instruction and the branch destination address of the branch instruction and stores the address of the branch instruction and the branch destination address of the branch instruction linked together. When the branch history unit 130 receives a branch instruction from the instruction readout unit 120, if storing a branch history relating to the received branch instruction, it outputs the branch destination address of that branch instruction to the instruction readout unit 120.

The instruction readout unit 120 reads out an instruction from the L1 cache memory 110. When the instruction readout unit 120 reads out a branch instruction from the L1 cache memory 110, the instruction readout unit 120 confirms with the branch history unit 130 if the history of execution of the read out branch instruction is in the branch history unit 130. If the history of execution of the read out branch instruction is in the branch history unit 130, the instruction readout unit 120 receives the branch destination address from the branch history unit 130 and reads out the instruction stored at the branch destination address from the L1 cache memory 110.

When the instruction readout unit 120 receives the instruction which is read out from the L1 cache memory 110, the instruction execution unit 140 executes the processing which is specified by that instruction on the data which is stored in the register 250. The “processing which is specified by that instruction” is, for example, a floating point operation, integer operation, address generation, branch instruction execution, a store operation which stores data which is stored in the register 250 in the L1 cache memory 110, or a load operation which loads data which is stored in the L1 cache memory 110 to the register 250. The instruction execution unit 140 is provided with execution units which perform the floating point operation, integer operation, address generation, branch instruction execution, and store or load operation and use these execution units to execute the above instruction processing.

The pipeline control unit 190 controls the processing relating to the units which are included in the processing unit 100 to be executed synchronized in cycle as illustrated in FIG. 4 so that the same units execute a plurality of instructions overlappingly. The pipeline control unit 190 operates as a branch control unit which controls speculative execution. When speculative execution of instruction at a branch destination fails, the branch control unit invalidates the result of execution of the speculative execution. When the speculative execution succeeds, the branch control unit stores the result of execution in the register 250 or the L1 cache memory 110.

The register 250 is one type of memory which stores data. The register 250 stores, for example, the result of calculation of the instruction execution unit 140, the addresses when reading and writing from and to the main storage device 520, and the operating state of the processing unit 100.

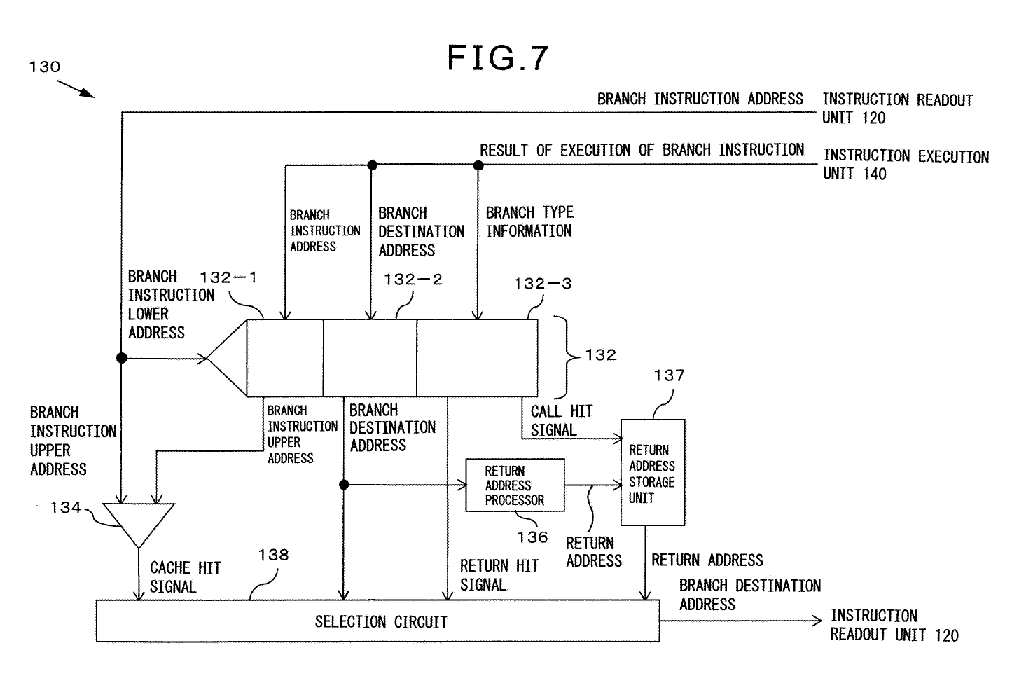

FIG. 7 is a view which illustrates one example of a branch history unit. As illustrated in FIG. 7, the branch history unit 130 has a branch history storage unit 132, comparison circuit 134, return address processor 136, return address storage unit 137, and selection circuit 138.

The branch history storage unit 132 has a branch instruction storage unit 132-1, branch destination instruction storage unit 132-2, and branch type information storage unit 132-3. The branch history storage unit 132 is, for example, a branch history table (BHT) which stores result of execution of a branch instruction receiving from the instruction execution unit 140. The results of execution of a branch instruction includes the address of the branch instruction, that is, the branch instruction address, the branch destination address of the branch instruction, and the branch type information. The “branch instruction address” is an address which specifies the storage location of a branch instruction at the main storage device 520. The “branch destination address” is an address which specifies the storage location of a branch destination instruction of a branch instruction in the main storage device 520. The “branch type information” is, for example, information which specifies a CALL instruction which calls up a subroutine, a return instruction for return from the subroutine to the main routine, and other branch instructions.

The branch history storage unit 132 stores the upper address of a branch instruction address, that is, the branch instruction upper address, in the branch instruction storage unit 132-1, the branch destination address in the branch destination instruction storage unit 132-2, and the branch type information in the branch type information storage unit 132-3. When storing the information, the branch history storage unit 132 uses the lower address of the branch instruction address, that is, the branch instruction lower address, as the index address.

When the branch history storage unit 132 receives a branch instruction address from the instruction readout unit 120, the branch history storage unit 132 uses the lower address of the received branch instruction address to search through the entries in the branch instruction storage unit 132-1 and outputs the resultant branch instruction upper address to the comparison circuit 134.

Further, when the branch history storage unit 132 receives a branch instruction address from the instruction readout unit 120, the branch history storage unit 132 outputs the branch destination address from the entry of the branch destination instruction storage unit 132-2 which is specified by the lower address of the branch instruction to the selection circuit 138 and return address processor 136.

Further, the branch history storage unit 132 outputs a call hit signal to the return address storage unit 137 when the branch type information of the CALL instruction was stored at an entry of the branch type information storage unit 132-3 which is specified by the lower address of the branch instruction which was received from the instruction readout unit 120. The branch history storage unit 132 outputs a return hit signal to the selection circuit 138 when the branch type information of the return instruction was stored at an entry of the branch type information storage unit 132-3 which is specified by the lower address of the branch instruction which was received from the instruction readout unit 120.

The comparison circuit 134 outputs a cache hit signal to the selection circuit 138 when the branch instruction upper address which is output from the branch instruction storage unit 132-1 and the branch instruction upper address which is received from the instruction readout unit 120 match.

When the return address processor 136 receives a branch destination address from the branch history storage unit 132, it the return address processor 136 processes the address right after the branch destination address, adds 4 bytes, the size of one instruction, to the branch destination address, and outputs the resultant address as the return address to the return address storage unit 137. The address right after the branch destination address is output as the return address because the return address differs from the branch destination address which is stored in the branch history storage unit 132 and becomes the address of the instruction right after the CALL instruction.

When the return address storage unit 137 receives a call hit signal from the branch history storage unit 132, it stores the return address which was output from the return address processor 136. When the branch history unit 130 reads out the return instruction of a subroutine, it outputs the return address which is stored in the return address processor 136 to the selection circuit 138.

The selection circuit 138 receives a cache hit signal from the comparison circuit 134, a branch destination address and return hit signal from the branch history storage unit 132, and a return address from the return address storage unit 137. The selection circuit 138 outputs the branch destination address which the selection circuit 138 receives from the branch history storage unit 132 to the instruction readout unit 120 when, for example, the signal level of the cache hit signal is “1” and the signal level of the return hit signal is “0”. Further, the selection circuit 138 outputs the return address which it received from the return address storage unit 137 to the instruction readout unit 120 when, for example, the signal level of the cache hit signal is “1” and the signal level of the return hit signal is “1”.

In this way, the branch history unit 130 outputs a branch destination address to the instruction readout unit in accordance with the type of the branch instruction receiving from the instruction readout unit 120.

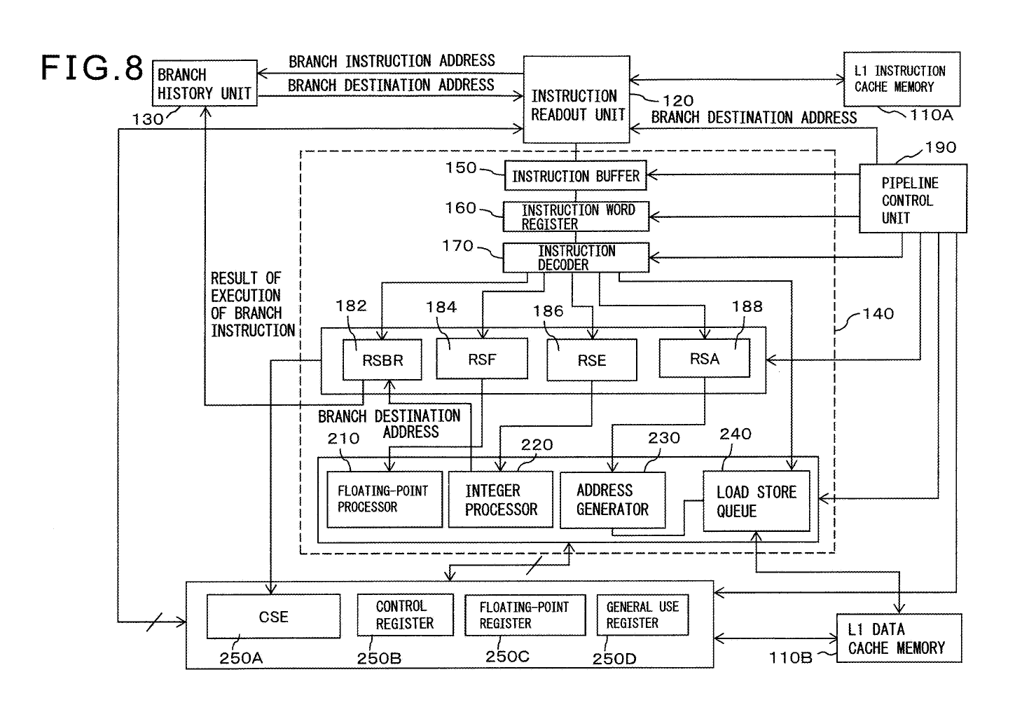

FIG. 8 is a view which illustrates one example of an instruction readout unit and instruction execution unit. In FIG. 8, the instruction execution unit 140 has an instruction buffer 150, instruction word register 160, and instruction decoder 170. The instruction execution unit 140 further has a branch reservation station (RSBR: reservation station for branch) 182. The instruction execution unit 140 further has a floating point reservation station (RSF: reservation station for floating point) 184. The instruction execution unit 140 further has an integer operation reservation station (RSE: reservation station for execution) 186. The instruction execution unit 140 further has an address generation reservation station (RSA: reservation station for address generation) 188.

The instruction execution unit 140 further has a floating point processor 210, integer processor 220, address generator 230, and load/store queue 240. The floating point processor 210, integer processor 220, address generator 230, and load/store queue 240 may be referred to as the “processors” in the embodiment of FIG. 8 below.

The pipeline control unit 190 controls the processing relating to the units which are included in the processing unit 100 so as to be executed for each of the plurality of stages of the pipeline. The units which the pipeline control unit 190 controls are the instruction readout unit 120, instruction buffer 150, instruction word register 160, instruction decoder 170, reservation stations 182 to 188, execution units 210 to 240, register 250, etc.

In FIG. 8, the L1 cache memory 110 which is illustrated in FIG. 6 is illustrated as a separated cache memory which has an L1 instruction cache memory 110A and L1 data cache memory 110B. The “L1 instruction cache memory 110A” is the L1 cache memory which stores instructions. The “L1 data cache memory 110B” is the L1 cache memory which stores data.

In FIG. 8, the register 250 which is illustrated in FIG. 6 is illustrated as a commit stack entry (CSE) 250A, control register 250B, floating point register 250C, and general use register 250D.

The instruction readout unit 120 reads out an instruction which is stored in the L1 instruction cache memory 110A by a fetch operation. Further, the instruction readout unit 120 reads out an instruction which is specified by an address on the main storage device 520 which is indicated by a later explained program counter from the L1 instruction cache memory 110A. When the instruction which is read out from the L1 instruction cache memory 110A is a branch instruction, the instruction readout unit 120 outputs the branch instruction to the branch history unit 130. When the branch history unit 130 has the branch history of the branch instruction which was output from the branch history unit 130, the instruction readout unit 120 receives the branch destination address of the branch instruction from the branch history unit 130.

The instruction readout unit 120 reads out the instruction of the condition branch destination address which it received from the branch history unit 130 from the L1 instruction cache memory 110A and outputs it to the instruction buffer 150. Further, the instruction readout unit 120 may make the instruction execution unit 140 start the execution of the branch destination instruction of the branch instruction before completing execution of the branch instruction. It is called the “speculative execution” to execute an instruction of a branch destination predicted by using the branch history unit 130 before the branch destination address of the branch instruction is definitively determined.

The CSE 250A is a register which manages an instruction in the middle of execution from when the instruction execution unit 140 issues the instruction to the instruction decoder 170 to when execution by the floating point processor 210 etc. is completed. The CSE 250A has a plurality of entries. When the instruction decoder 170 outputs an instruction output, the entries of the CSE 250A stores identification information which corresponds to the output instruction, the execution status, and other data. The data of the entries of the CSE 250A are erased upon the receipt of an execution completion signal which indicates execution completion (commit) of the instruction from the processor. The pipeline control unit 190 determines the execution completion of an instruction based on the result of branch prediction, invalidates the results of speculative execution when the speculative execution fails, and stores the result of execution in the memory when the speculative execution succeeds. The data which is erased from the entries of the CSE 250A due to the execution completion signal is stored in the register 250 or the L1 cache memory 110 and utilized for execution of other instructions. On the other hand, an instruction which is invalidated by the pipeline control unit 190 due to failure of the speculative execution etc. is erased from the entries of the CSE 250A, reservation stations, and other resources and is not stored in the register 250 and the L1 cache memory 110 and is not utilized for execution of other instructions.

The control register 250B is for example a register which stores an address space identifier (ASI) which unambiguously designates an address space to which a virtual address used belongs or a program counter which designates an address of the main storage device 520 in which an instruction to be executed next is stored.

The floating point register 250C is a register which stores the results of execution of the floating point processor 210. The general use register 250D is a register which stores the results of execution of the integer processor 220.

The instruction buffer 150 is a buffer which temporarily stores an instruction which the instruction readout unit 120 outputs. The instruction buffer 150 can store an instruction which the instruction readout unit 120 outputs even when, for example, the executed operations by the floating point processor 210, integer processor 220, address generator 230, etc. stop.

The instruction word register 160 stores a plurality of instructions which are to be executed simultaneously, among the instructions which are stored by the instruction readout unit 120 in the instruction buffer 150, at the same timing. For example, the instruction word register 160 stores four instructions at the same timing.

The instruction decoder 170 decodes the plurality of instructions which are stored in the instruction word register 160. The bit string of one part of an instruction is called an “instruction code” (opcode) and shows the type of the instruction. The other part is the field which specifies the operand. An “operand” is a quantity on which an operation is performed and indicates a value or variable covered by an operation which is specified by an instruction code. An operand is, for example, an address of a register which stores input values to be covered by an operation and an address of a register which stores the results of the operation. The instruction decoder 170 outputs the decoded instruction to any of the reservation stations corresponding to the decoded instruction code.

The reservation stations are buffer circuits which store the decoded results of the instructions which are output from the processors and load the stored decoded results of the instructions and operands to the processors at predetermined timings. They have pluralities of entries. Each entry stores the decoded results of an instruction which is output from the instruction decoder 170 and the operand which is output from the address of the register which is designated by the instruction. The pipeline control unit 190 outputs the operands to the corresponding execution units when the reservation stations store decoded results of instructions and operands at all of the entries and the processors can execute them.

RSF 184 is a reservation station which corresponds to the floating point processor 210. RSE 186 is a reservation station which corresponds to the integer processor 220. RSA 188 is a reservation station which corresponds to the address generator 230.

RSBR 182 is a reservation station which has a plurality of entries for storing instruction identification information which is included in decoded results of a branch instruction and instruction identification information of an instruction for generating a condition code which controls branching of a branch instruction or an instruction which performs speculative execution linked together. The pipeline control unit 190 compares the branch destination address of a branch instruction and the address of a speculatively executed instruction. When the branch destination address of the branch instruction and the address of the speculatively executed instruction match (below, referred to as “success of speculative execution”), the entry of the branch instruction and the entry of the branch destination instruction in the CSE 250A are committed and completed. On the other hand, when the branch destination address of the branch instruction and the address of the speculatively executed instruction do not match (below, referred to as “failure of speculative execution”), the entry of the branch instruction in the CSE 250A is committed and completed, but the entry of speculatively executed branch destination instruction is cancelled. After that, the instruction right after the branch instruction is stored in the CSE 250A and the instruction right after the branch instruction is executed by the processors.

Note that, if the speculative execution fails, the pipeline control unit 190 outputs the branch destination address of the branch instruction to the instruction readout unit 120 as the results of execution of the speculative execution, whereby the instruction readout unit 120 can read out the instruction from the correct branch destination address and the instruction of the branch destination of the branch instruction is executed.

The integer processor 220 follows the instruction code and executes an addition/subtraction logic operation, shift operation, multiplication/division, etc. on the integer. The floating point processor follows the instruction code and executes addition, subtraction, multiplication, division, a square root operation. on the floating point. The address generator 230 follows the load instruction or store instruction or other instruction code relating to memory access to generate the address for memory access.

The load/store queue 240 has a plurality of entries which store memory access instructions and addresses. The plurality of entries of the load/store queue 24 are secured in accordance with the order of execution of instructions of the instruction decoder 170. The load/store queue 240 receives decoded information relating to the memory access instructions in accordance with the order of execution of instructions from the instruction decoder 170. When the load/store queue 240 receives the addresses of the memory access instructions which are output from the instruction decoder from the address generator 230, it accesses the L1 data cache memory 110B in accordance with the order of execution of the instructions from the instruction decoder.

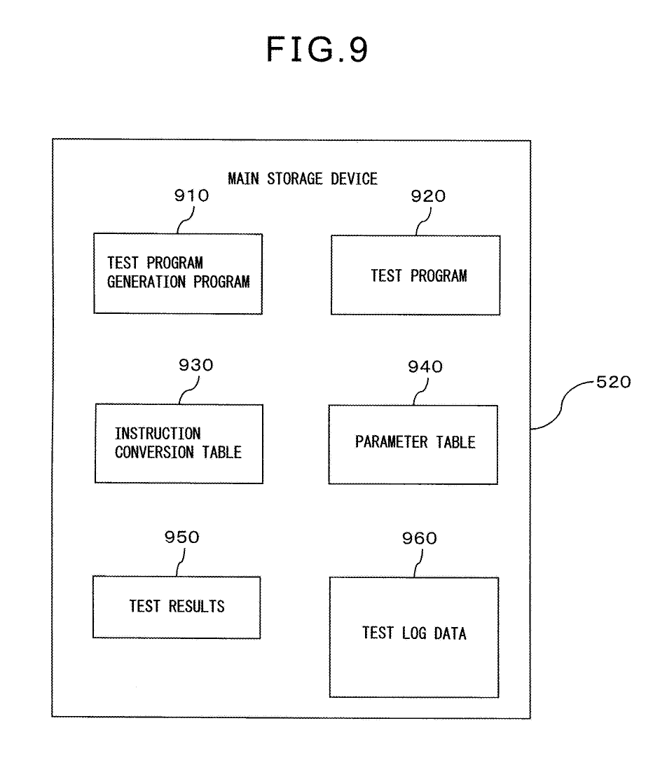

Next, referring to FIG. 9 to FIG. 13, the information which is stored in the main storage device 520 will be explained.

FIG. 9 is a view which illustrates one example of a main storage device. The main storage device 520 which is shown in FIG. 9 stores a test program generation program 910, test program 920, instruction conversion table 930, parameter table 940, test results 950, and test log data 960.

The test program generation program 910 is a program which makes an information processing system 500 or other computer generate a test program 920. For example, the processing device 510 of the information processing system 500 which is illustrated in FIG. 5 executes the test program generation program 910 whereby the information processing system 500 operates as a test program generator which generates the test program 920.

The test program 920 is a program which tests the operation of the processing system. For example, the processing device 510 of the information processing system 500 which is illustrated in FIG. 5 executes the test program 920 whereby the information processing system 500 operates as a test program controller. Note that, details of the test program will be explained later.

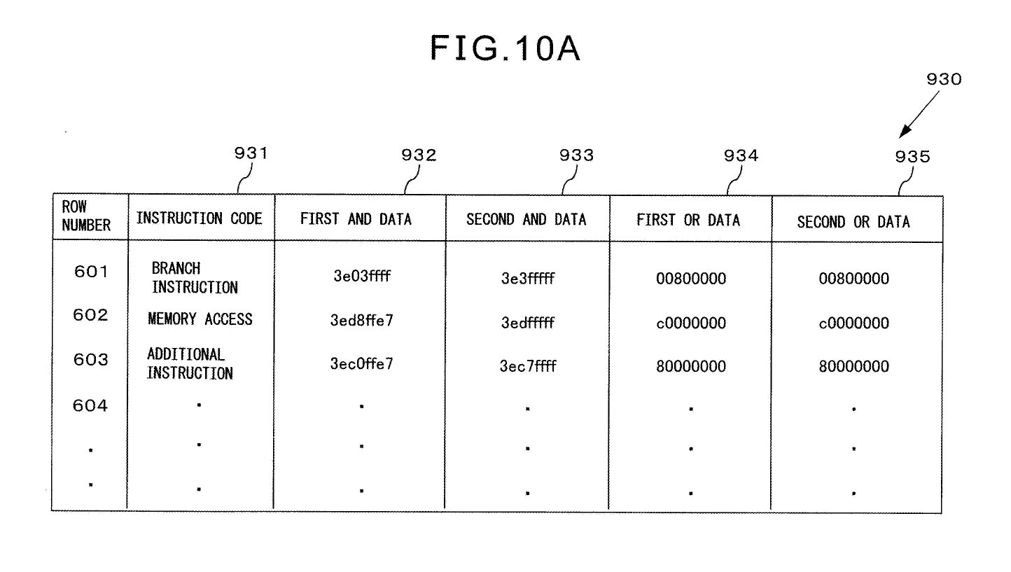

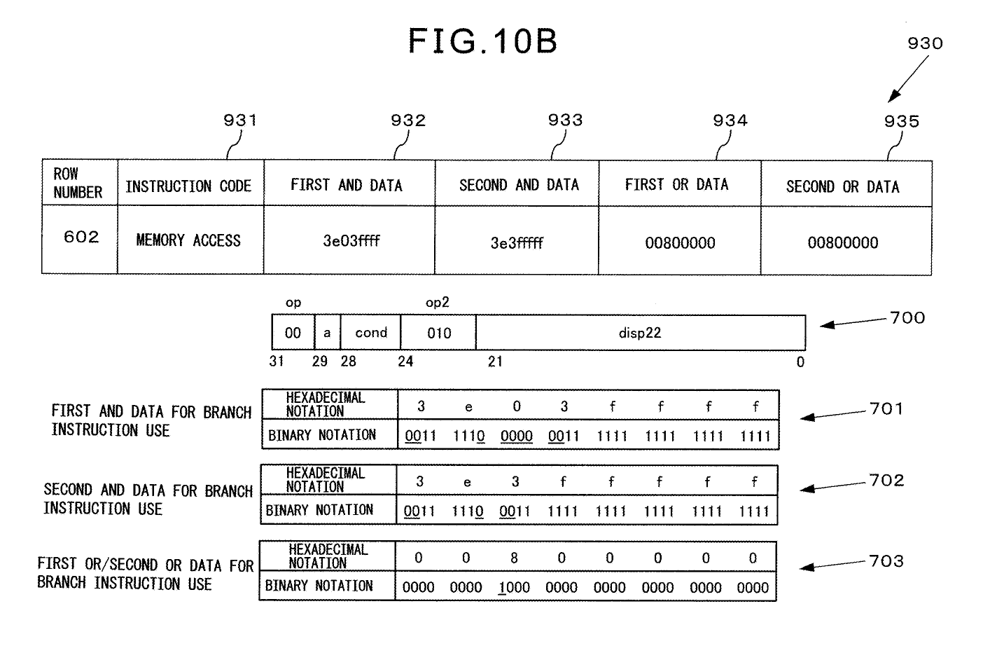

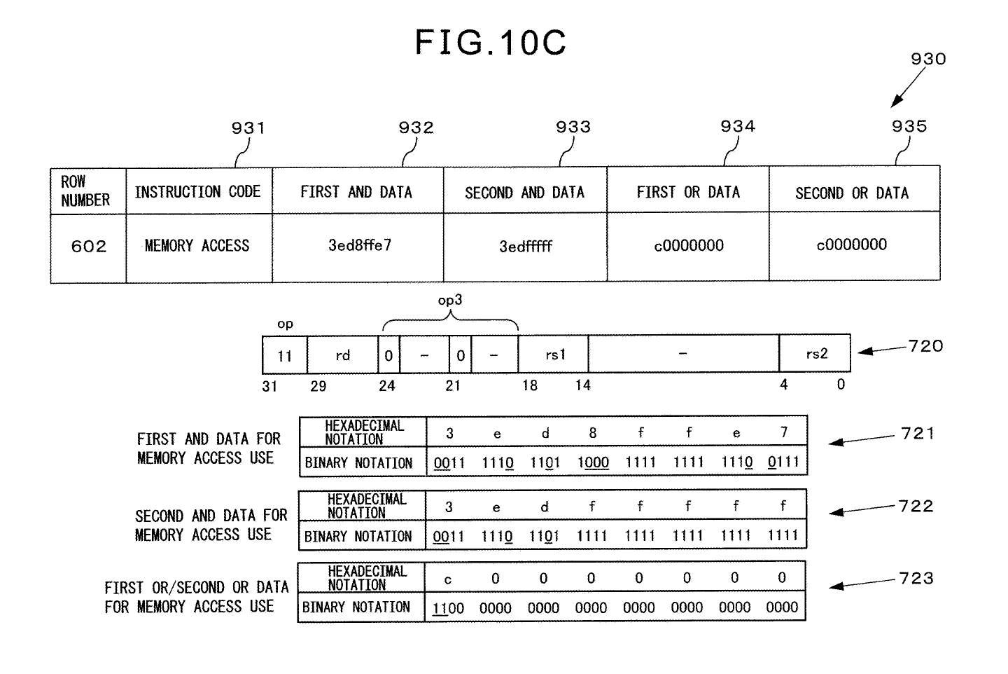

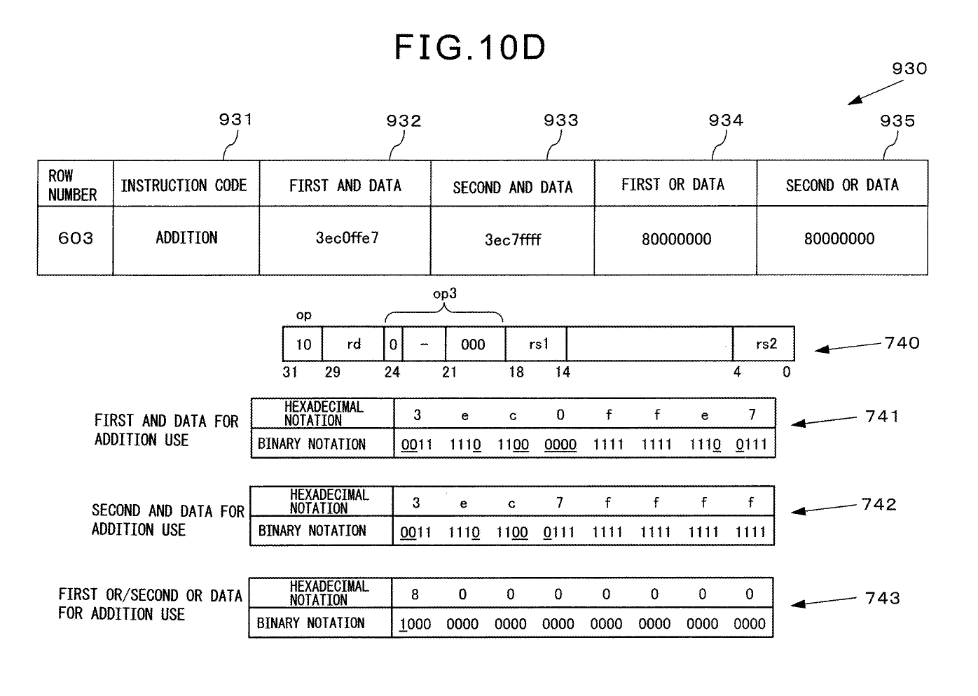

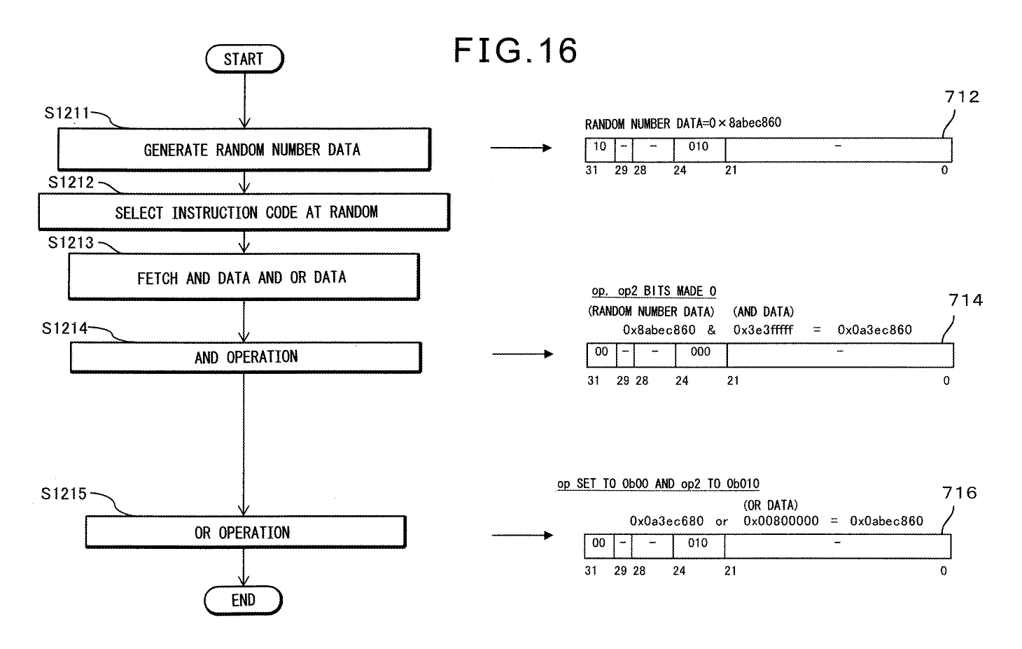

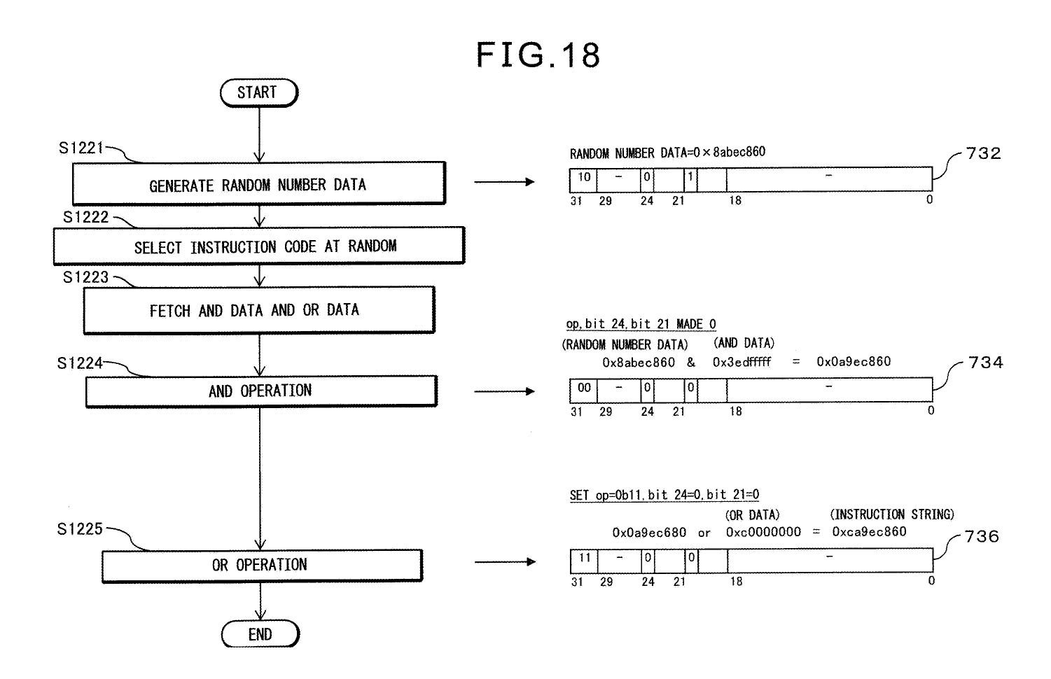

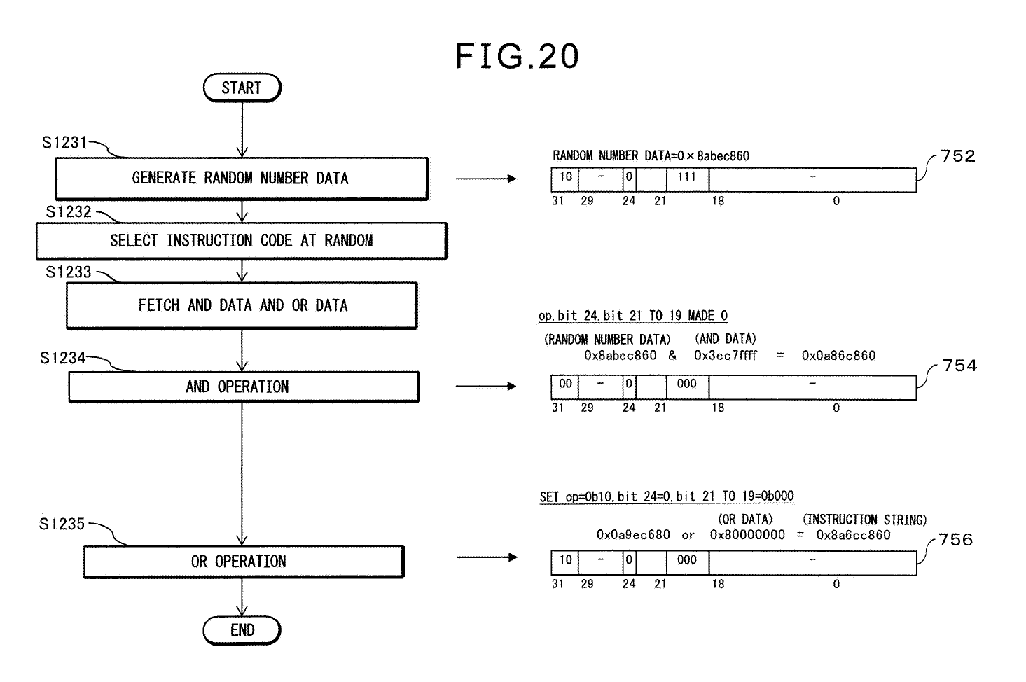

FIGS. 10A to 10D are views which illustrates one example of an instruction conversion table. The instruction conversion table which is illustrated in FIGS. 10A to 10D records information on the correspondence between AND data and OR data for each instruction code. By multiplying the AND data or OR data of the instruction conversion table 112 with a random number, test instructions are generated. The test program includes random instructions and random number data. A “random instruction” is an instruction which matches a predetermined instruction code and is generated complying the test protocols. “Random number data” includes data comprised of only random numbers and random number instructions which do not comply with the test protocols and which have parts of the random number data replaced with instruction codes. The instruction conversion table is used for the generation of random instructions and random number instructions. An example of generation of a random number instruction will be explained later using FIG. 16, FIG. 18, and FIG. 20.

FIG. 10A is a view which illustrates one example of an instruction conversion table. The instruction conversion table 930 which is illustrated in FIG. 10A has a column 931 of instruction codes, a column 932 of first AND data, a column 933 of second AND data, a column 934 of first OR data, and a column 935 of second OR data. Each row of the instruction conversion table 930 receives as input an instruction code and first AND data, second AND data, first OR data, and second OR data which correspond to the instruction code.

The first AND data and the first OR data are used for generating a random instruction. To generate a random instruction, the first AND data is data which is used in an AND operation for making the instruction code part and the bit part which is limited by the test protocols “0”. The first OR data is data which is used in an OR operation for generating an instruction code after an AND operation by making at least part of the bit part which corresponds to the instruction code which is limited by the test protocols “1”.

The second AND data and the second OR data are used for generation of a random number instruction. The second AND data is data which is used in an AND operation for making the bit part corresponding to the instruction code “0”. The second OR data is data which is used in OR operation for generating an instruction code after an AND operation by making at least part of the bit part which corresponds to the instruction code “1”.

FIG. 10B is a view which explains one example of AND/OR data which is used for generation of a random instruction or a random number instruction of a branch instruction. 700 shows the instruction format of a branch instruction. The instruction code has the 31 and 30 bits of “0” and the 24 to 22 bits of “010”. Further, as test protocols, it is prescribed that the top 4 bits of “disp22” which indicated the branch destination address be made “0”.

Therefore, the first AND data 701 for branch instruction use becomes data with the instruction code part of the branch instruction and the test protocol part of the branch instruction made “0”. Further, the second AND data 702 for branch instruction use becomes data with only the instruction code part of the branch instruction made “0”. The first OR data and second OR data for branch instruction use are data making only the 23 bits of the instruction format “1”, so the two are the same in format.

FIG. 10C is a view which explains one example of AND/OR data which is used for generation of a random instruction or random number instruction of a memory access instruction. 720 shows the instruction format of a memory access instruction. The instruction code has the 31 and 30 bits of “1”, the 24 bit of “0”, and the 21 bit of “0”. Further, as test protocols, it is prescribed that the top 3 bits of “rs1” be “0” and the top 2 bits of rs2 be “0”.

Therefore, the first AND data 721 for memory access use becomes data with the instruction code part of the memory access instruction and the test protocol part of the memory access instruction made “0”. Further, the second AND data 722 for memory access use becomes data with only the instruction code part of the memory access instruction made “0”. The first OR data and second OR data for memory access instruction use are data which make only the 31 and 30 bits of the instruction format “1”, so the two are the same in format.

FIG. 10D is a view which explains one example of AND/OR data which is used for generation of a random instruction or random number instruction of an addition instruction. 740 shows the instruction format of an addition instruction of one of the operation instructions. The instruction code has the 31 and 30 bits of “10”, the 24 bit of “0”, and the 21 to 19 bits of “0”. Further, as test protocols, it is prescribed that the top 3 bits of “rs1” be “0” and the top 2 bits of rs2 be “0”.

Therefore, the first AND data 741 for addition instruction use becomes data with the instruction code part of the addition instruction and the test protocol part of the branch instruction made “0”. Further, the second AND data 742 for addition instruction use becomes data with only the instruction code part of the addition instruction made “0”. The first OR data and second OR data for addition instruction use are data which make only the 31 bits of the instruction format “1”, so the two are the same in format.

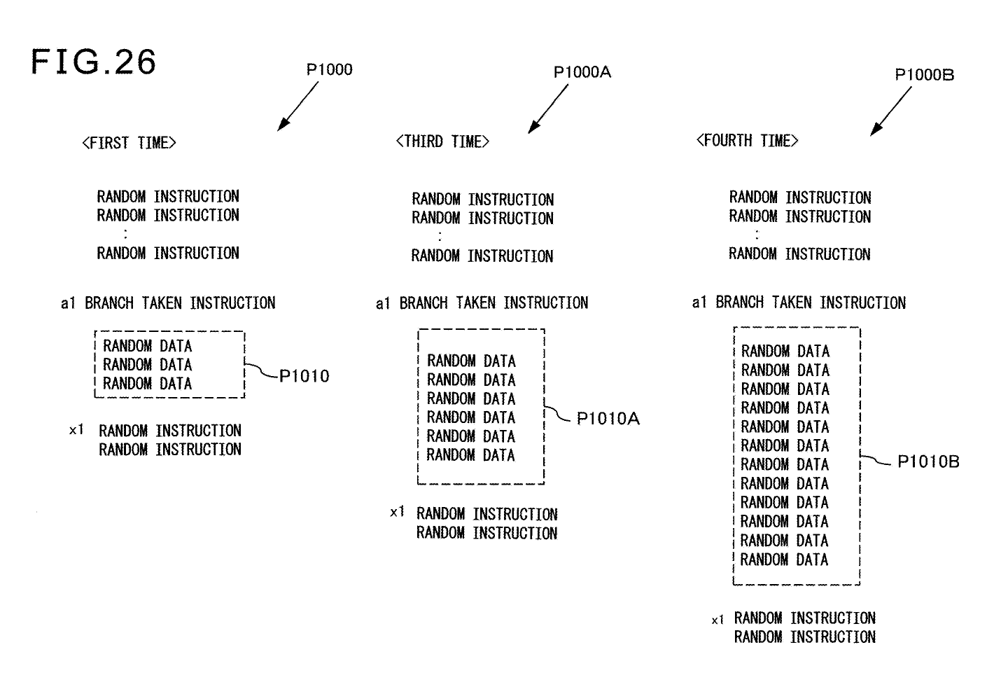

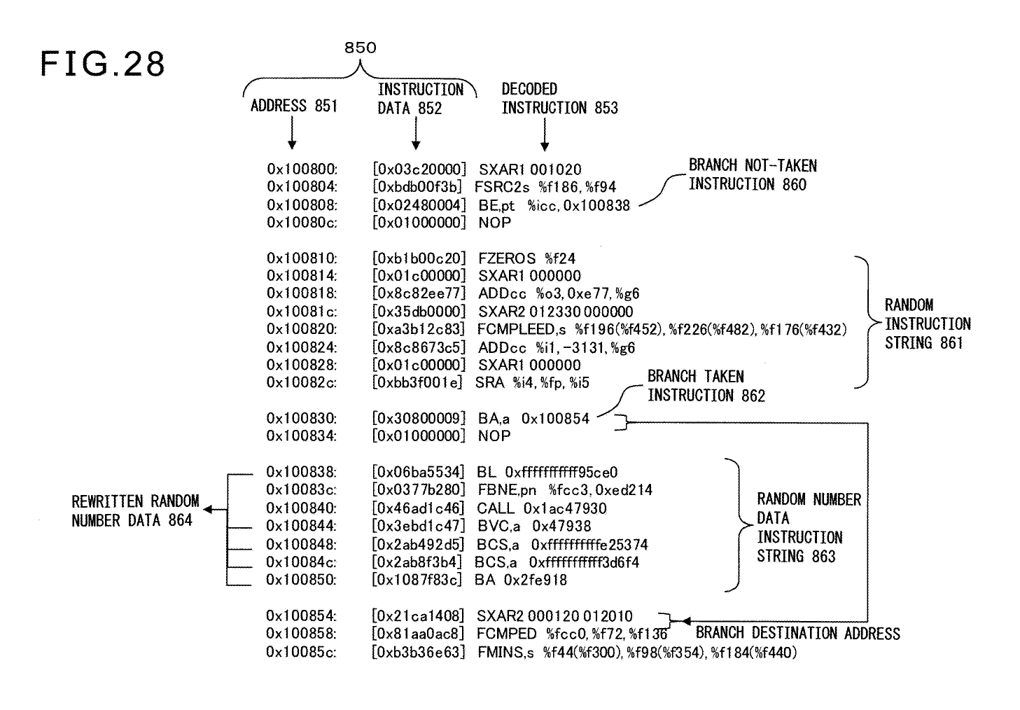

In the test program, by increasing the number of random number data which the processors can execute, it is possible to improve the operating rate of the processors when executing a single test program. Note that, the random number data sometimes matches a predetermined instruction format without being rewritten using the second AND data and second OR data. For this reason, the test program generation program need not make the computer executing the program rewrite all of the random number data by AND and OR operations. Note that, in the test program, an example of random number data and a random number instruction which changes the random number data by AND and OR operations to a predetermined instruction format will be explained later using FIG. 26 and FIG. 28.

Further, the input values of the first AND data, second AND data, first OR data, and second OR data which are illustrated in FIGS. 10A to 10D will be referred to in the explanation of the generation of a random instruction and the generation of a random number instruction explained later.

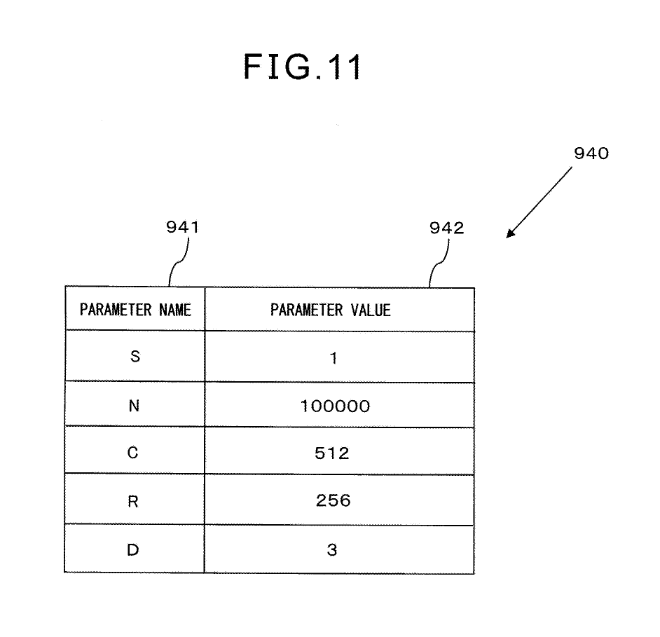

FIG. 11 is a view which illustrates one example of a parameter table. The parameter table 940 is a table in which parameters which are utilized at the time of the flow of processing for execution of the test program are set. The parameters which are contained in the parameter table 940 are referred to by the processing system when the processing system generates the test instructions.

The parameter table 940 which is illustrated in FIG. 11 has a column 941 of the parameter names and a column 942 of the parameter values. The column 941 of the parameter names includes the seed value S, number N of instructions generated, trap instruction generation interval C, random number data generation interval R, and number D of instructions of random number data D, while the parameter value column 942 receives as input the parameter values which correspond to the parameter names. The rows of the parameter table 940 receive as input the parameters corresponding to the parameter names.

The seed value S is the seed value which is used for generation of the random number data. As illustrated in FIG. 11, the seed value S is, for example, “1”. The number N of instructions generated is the number of instructions which are generated. As illustrated in FIG. 11, the number N of instructions generated is, for example, “100000”.

The “trap instruction generation interval C” shows the number of instructions between one trap instruction and the trap instruction which is generated after that trap instruction. Note that, a “trap instruction” is an instruction which outputs the values of the register 250 after execution of the test instructions and the test results 950 which are written into the main storage device 520 to the main storage device 520 as test log data 960. For example, when the trap instruction generation interval C is “512”, the test program generator further generates a trap instruction after 512 instructions after a generated trap instruction.

The “random number data generation interval R” is the interval of generation of one random number data and another random number data in a test instruction string by the test program generator. For example, the test program generator stores the instruction count which is shown by the instruction counter when generating the previous random number data. When the current instruction counter counts up from the stored instruction count to the instruction count adding the random number data generation interval, the test program generator again generates random number data. As illustrated in FIG. 11, the random number data generation interval R is, for example, “256”.

D is the number of random number data. Note that, the number of random number data D is the initial value. The test program generator can change the number of random number data in the range of 1 to 64 to change the number of random number data which is generated. As illustrated in FIG. 11, the random number data D is, for example, “3”. This shows that three instructions of random number data are generated.

The parameter values which are illustrated in FIG. 11 are referred to in the explanation of the processing for generation of a test program by the test program generator which is given later.

The test results 950 which are illustrated in FIG. 9 are the results of execution of the test program which the processing device 510 outputs to the main storage device 520 as a result of the processing device 510 executing the test program 920. The area in the main storage device 520 where the test results 950 are stored is referred to as the “test area”. In other words, the “test area” is the part of the storage area where the results of execution by the test instruction string are output. As illustrated, the test area is limited to a predetermined part of the storage area inside the main storage device so that execution of the test program 920 does not change the other data which is stored in the main storage device.

The test log data 960 which is illustrated in FIG. 9 means the data which is generated by the processing device executing the trap instruction and is stored in the register 250 after execution of the test instructions, and the test results which were moved to the storage area of the test log data 960. The test program 920 is sometimes executed several times by the processing device 510. In this case, the processing device 510 executes the trap instruction several times so the test results are stored in different parts of the storage area together with the number of times of testing of the test program. Further, when a test program which includes different instructions is executed, the processing device 510 executes a trap instruction whereby it stores the results of execution of the test program together with unambiguously identifiable identification information in the storage area.

As explained above, the information processing system 500 operates as a “test program generator” by executing the test program generation program 910 which is stored in the main storage device 520. Further, the information processing system 500 operates as a “test controller” which executes a test program 920 which is stored in the main storage device 520 so as to test its own processing device 510. In this way, a single information processing system 500 can operate as the “test program generator” and the “test controller”.

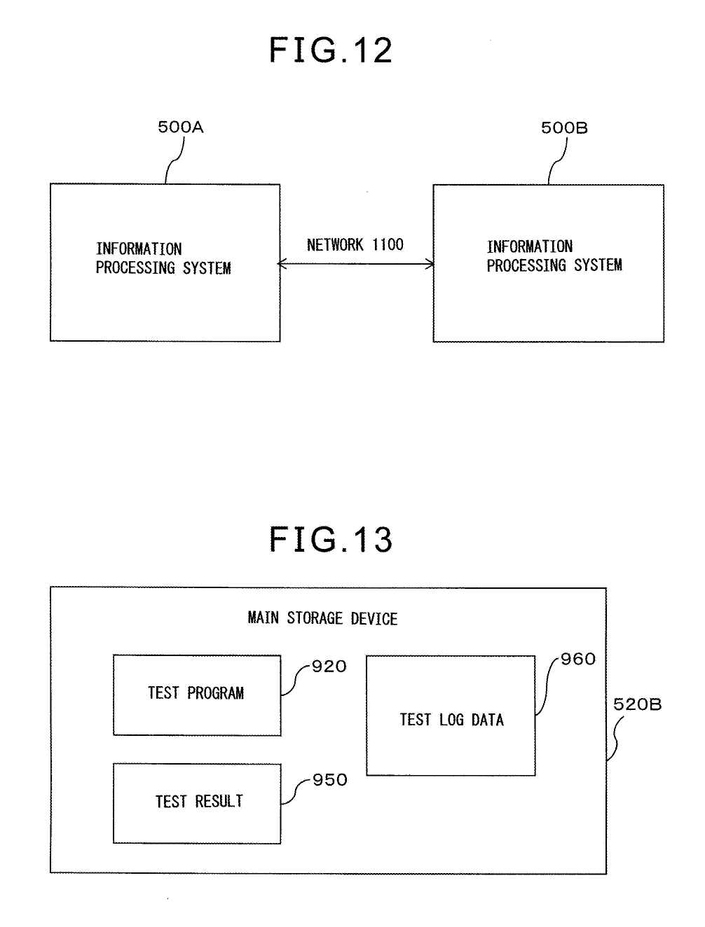

Next, referring to FIG. 12 and FIG. 13, the case where the “test program generator” and the “test controller” are configured to be different information processing systems will be explained.

FIG. 12 is a view which illustrates one example of a test program generator and a test controller. The information processing systems 500A and 500B which are illustrated in FIG. 12 may also have the same constitutions as the information processing system which is illustrated in FIG. 5. The information processing system 500A operates as a test program generator which executes the test program generation program 910 to generate the test program 920 and sends the generated test program 920 through the network 1100 to the information processing system 500B. Further, the information processing system 500B executes the test program 920 so as to operate as a test controller which tests the processing device 510 of the information processing system 500B. In this way, the generation of the test program and the execution of the test program may be performed by two information processing systems 500.

FIG. 13 is a view which illustrates one example of the main storage device of the test controller. When the main storage device 520B of the information processing system 500B which is illustrated in FIG. 13 receives the test program 920 from the information processing system 500A, it stores it in the main storage device 520B. The test program 920 is executed by the processing system whereby the main storage device 520B stores the test results 950 and test log data 960. As explained using FIG. 12 and FIG. 13, the generation of the test program and the execution of the test program are performed using two information processing systems.

[5] Generation of Random Number Data Unconstrained by Test Protocols

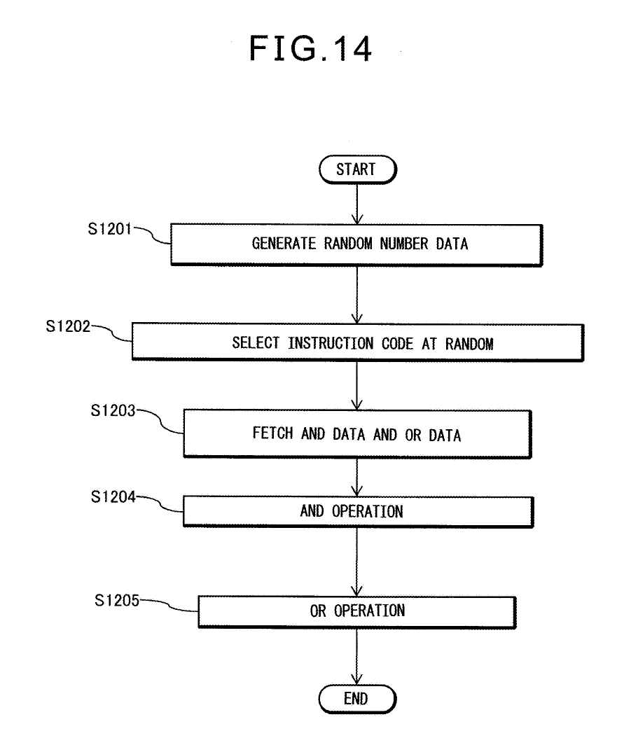

Below, referring to FIG. 14 to FIG. 20, the method of generation of a test program and the test control method using execution of the test program will be explained.

As explained in [1] test protocols, to verify the validity of the results of test execution, test instructions are generated in accordance with test protocols. However, with execution of test instructions based on test protocols, it is difficult to verify the operation at the time when a processing system actually executes instructions, so random number data unconstrained by test protocols are generated and used.

The test program may include not only random number data comprised of random numbers, but also instructions which replace part of the random number data with instruction codes. Below, instructions which replace part of the random numbers with instructions codes and which are unconstrained by the test protocols will be called “random number instructions”. This is because when instructions unconstrained by the test protocols are random number data comprised of only random numbers, the instruction decoder 170 may fail to divide the random number data into instruction codes and operands in accordance with the instruction set of the processing device 510. On th other hand, the random instructions are divided into instruction codes and operands.

FIG. 14 is a view which illustrates one example of a flow of generation of a random number instruction. First, the processing system which executes the test program generation program generates random number data based on a seed value (S1201). Note that, the seed value is included in the parameter table 940, so the processing system fetches the seed value from the parameter table 940 of the main storage device to generate the random number data. The processing system randomly selects an instruction code (S1202). The processing system searches for the selected instruction code through the instruction conversion table 930 and fetches AND data and OR data which correspond to the selected instruction code (S1203). The processing system processes the random number data which was generated at step S1201 by multiplying it with the AND data which was fetched at step S1203 under AND conditions (S1204). The processing system processes the random number data which was multiplied under the AND conditions of step S1204 by multiplying it with the OR data which was fetched at step S1203 under OR conditions (S1205), generates random number instructions, and then ends the flow of generation of the random number instruction.

[5.1] Method of Generation of Branch Instruction not Complying with Test Protocols

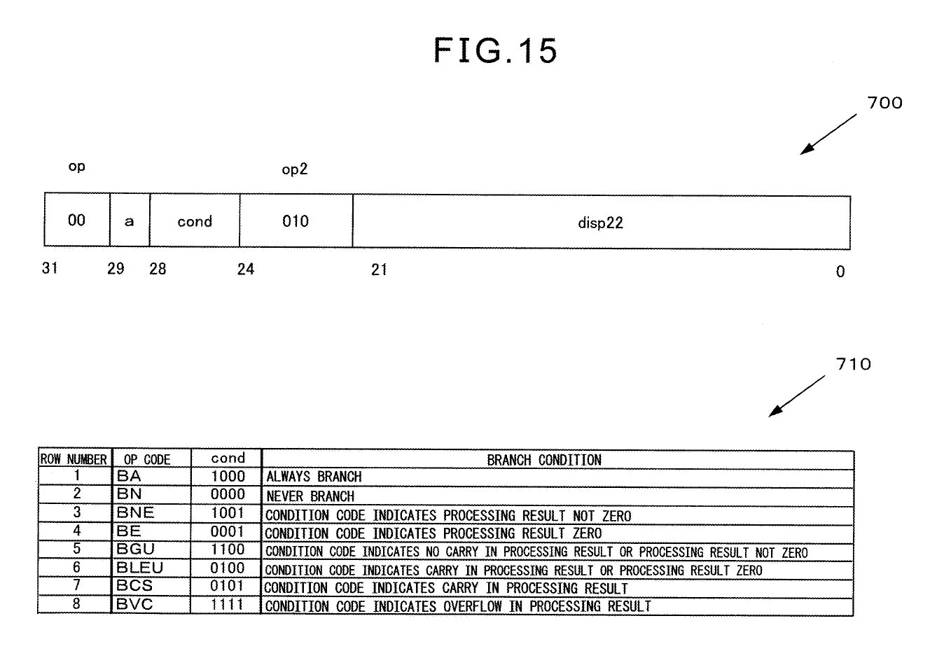

FIG. 15 is a view which illustrates one example of a branch instruction. The instruction format 700 which is illustrated in FIG. 15 is the instruction format of a branch instruction of the SPARC® instruction set. Table 710 which is illustrated in FIG. 15 is a table which shows one example of branch instructions and branch conditions.

The instruction format 700 of the branch instruction specifies the opcode of a branch instruction by the 31 to 30 bits “op” and the 24 to 22 bits “op2”. The 29 bit “a” is the instruction invalidation (invalid) bit, while the 28 to 25 bits “cond” are bits which specify a specific branch instruction. “cond”, for example, when the invalidation bit is “1”, indicates to execute an instruction right after the branch instruction when a branch is taken and to not execute an instruction right after the branch instruction, but to invalidate the instruction right after the branch instruction when a branch is not taken. The 21 to 0 bits “disp22” specify the branch destination address.

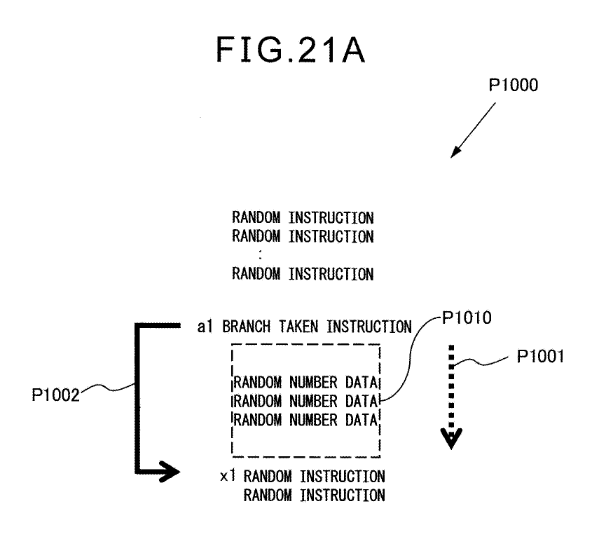

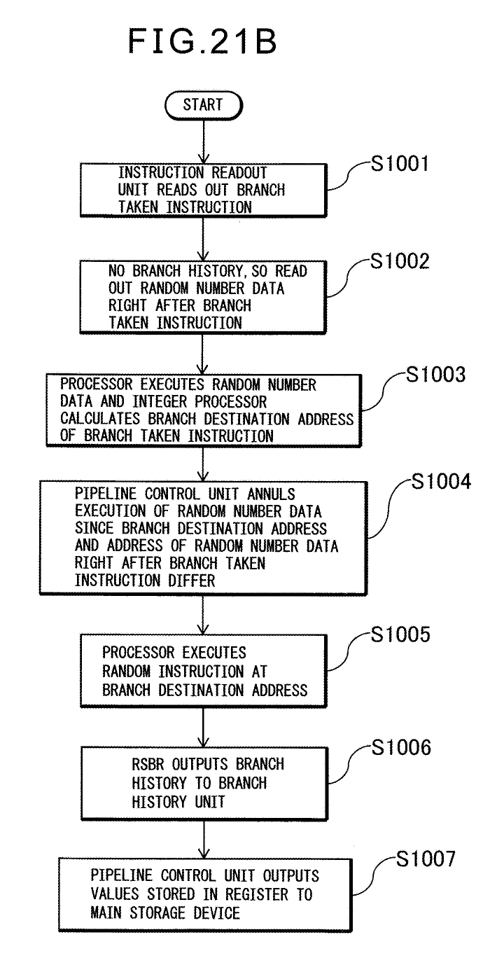

Table 710, Row No. 1 explains “BA (branch always)” of one of the branch taken instructions. When the value of “cond” is “1000”, it indicates that the opcode is “BA”. “BA” is an unconditional branch instruction which unconditionally commands branching to the branch destination without referring to the condition code. “BA” is one example of the branch taken instructions which are illustrated in FIG. 21A to FIG. 26 explained later.

Table 710, Row No. 2 explains “BN (branch never)” of one of the branch not-taken instructions. The “cond” of “0000” indicates “BN”. “BN” is a nonbranch instruction which unconditionally commands no branching to the branch address without referring to the condition code. “BN” is one example of the branch not-taken instructions which are illustrated in FIG. 21A to FIG. 26 explained later.

Row Nos. 3 to 8 are examples of conditional branch instructions. Table 710, Row No. 3 explains “BNE (Branch on Not Equal)”. The “cond” of “1001” indicates “BNE”. “BNE” is an instruction which commands branching when a branch condition of “condition code indicates not processing results not zero” is satisfied.

Table 710, Row No. 4 explains “BE (Branch on Equal)”. The “cond” of “0001” indicates “BE”. “BE” is an instruction which commands branching when a branch condition of “condition code indicates processing results zero” is satisfied.

Table 710, Row No. 5 explains “BGU (Branch on Greater Unsigned)”. The “cond” of “1100” indicates “BGU”. “BGU” is an instruction which commands branching when a branch condition of “condition code indicates no carry operation in results of the operation or processing results not zero” is satisfied.

Table 710, Row No. 6 explains “BLEU (Branch on Less or Equal Unsigned)”. The “cond” of “0100” indicates “BLEU”. “BLEU” is an instruction which commands branching when a branch condition of “condition code indicates a carry operation in results of the operation or processing results zero” is satisfied.

Table 710, Row No. 7 explains “BCS (Branch on Carry Set)”. The “cond” of “1100” indicates “BCS”. “BCS” is an instruction which commands branching when a branch condition of “condition code indicates a carry operation in results of the operation” is satisfied.

Table 710, Row No. 8 explains “BVC (Branch on Overflow Clear)”. The “cond” of “1100” indicates “BCS”. “BCS” is an instruction which commands branching when a branch condition of “condition code indicates overflow in results of the operation” is satisfied.

By specifying the 31 to 30 bits “op” and 24 to 22 bits “op2” of a branch instruction by an AND operation and OR operation corresponding to the branch instruction and specifying the 29 bit “a” and the 28 to 25 bits “cond” by random numbers, various branch instructions are generated by random numbers.

FIG. 16 is a view which illustrates one example of an instruction generation method of a branch instruction. Using FIG. 16, the flow of generation of a branch instruction from random number data will be explained in accordance with the flow of an instruction which is illustrated in FIG. 14. At step S1211 which is illustrated in FIG. 16, the processing system generates the random number data 712. The random number data 712 is “0x8abec860”.

The test controller selects the instruction code to be generated (S1212). In the example of FIG. 16, the selected instruction is a branch instruction. The processing system fetches the AND data and OR data which correspond to the selected instruction code from the instruction conversion table 930 (S1213). The AND data is data which makes the bit string which corresponds to the instruction code “0”. Accordingly, the AND data has an instruction format in which the 31 to 30 bits and the 24 to 22 bits are “0” and the other bits are “1”, that is, “3e3fffff”. The OR data is data which makes the bit string which corresponds to the instruction code the instruction which was selected at step S1202. Accordingly, the OR data has an instruction format in which the 31 to 30 bits are “00”, the 24 to 22 bits are “010”, and the other bits are “0”, that is, “0x00700000”.

The test controller multiplies the random number data 712 of “0x8abec860” with the AND data of “0x3e3fffff” (S1214). The generated multiplied data 714 is “0x0a3ec860”.

The test controller multiplies the data “0x0a3ec860” after the AND operation with the OR data “0x00700000” (S1215). The generated multiplied data 716 is “0x0abec860”.

In this way, the test controller generates an instruction code which the instruction decoder 170 is able to read as the branch instruction.

[5.2] Method of Generation of Memory Access Instruction not Complying with Test Protocols

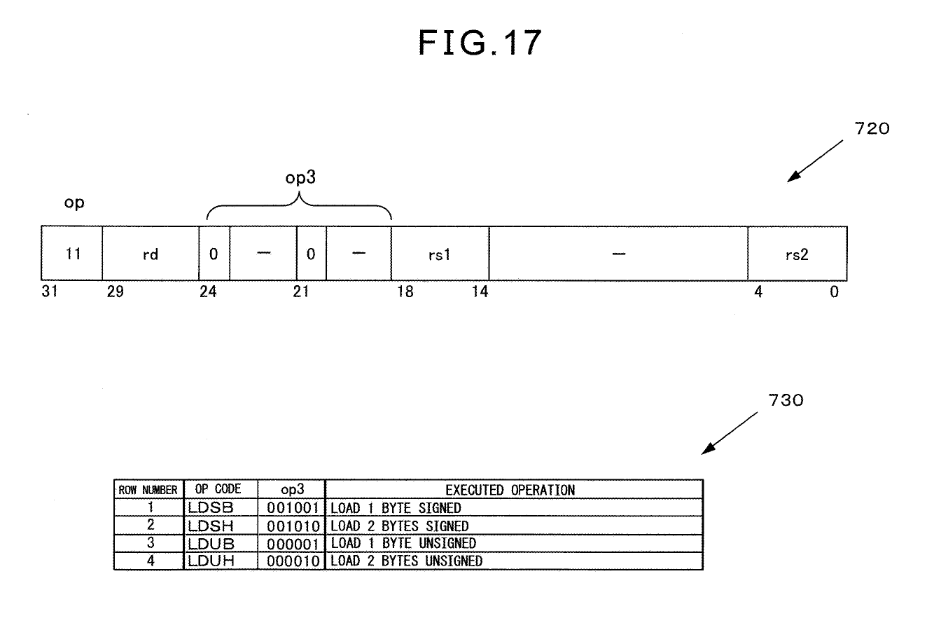

FIG. 17 is a view which illustrates one example of a memory access instruction. The instruction format 720 which is illustrated in FIG. 17 is the instruction format of an integer load instruction of one of the memory access instructions of the SPARC® instruction set. The table 730 which is illustrated in FIG. 17 is a table which illustrates one example of the integer load instructions and executed operations.

In the instruction format 720 of an integer load instruction, the 31 to 30 bits “op” and the 24 and 21 bits “0” specify the integer load instruction. The 31 to 30 bits “op” and the 24 to 19 bits “op3” specify the opcode of the integer load instruction. The “rs1” in the 18 to 14 bit field and the “rs2” in the 4 to 0 bit field show the address of the input register. The “rd” in the 29 to 25 bit field show the address of the output register.

Table 3, Row No. 1 explains the opcode “LDSB (LoaD Signed Byte)” of the integer load instruction. “op3” of “001001” indicates “LDSB”. “LDSB” specifies the operation of execution of loading 1 byte with a sign.

Table 3, Row No. 2 explains the opcode “LDSH(LoaD Signed Halfword)” of the integer load instruction. “op3” of “001010” indicates “LDSH”. “LDSH” specifies the operation of execution of loading 2 bytes with a sign.

Table 3, Row No. 3 explains the opcode “LDUB (LoaD Unsigned Byte)” of the integer load instruction. “op3” of “000001” indicates “LDUB”. “LDUB” specifies the operation of execution of loading 1 byte with no sign.

Table 3, Row No. 4 explains the opcode “LDUH (LoaD Unsigned Halfword)” of the integer load instruction. “op3” of “000010” indicates “LDUH”. “LDUH” specifies the operation of execution of loading 2 bytes with no sign.

By specifying “op” and the 24 and 21 bits in “op3” by an AND operation and OR operation corresponding to the integer load instruction and specifying the 23, 22, 20, and 19 bits of “op3” by random numbers, various integer load instructions can be generated.

FIG. 18 is a view which illustrates one example of a method of generation of a memory access instruction. Using FIG. 18, the flow of generation of an integer load instruction from random number data will be explained in accordance with the flow of generation of an instruction which is illustrated in FIG. 14. At step S1221 which is illustrated in FIG. 18, the processing system generates the random number data 732. The random number data 732 is “0x8abec860”.

The test controller selects the generated instruction code (S1222). The selected instruction, in the example of FIG. 18, is an integer load instruction. The processing system fetches the AND data and OR data which correspond to the selected instruction code from the instruction conversion table 930 (S1223). The fetched data is the AND data “0x3edfffff” and OR data “0xc0000000” which correspond to the instruction code which is shown in Row No. 605 of the instruction conversion table which is illustrated in FIG. 10A.

The AND data is data which makes the bit string which corresponds to the instruction code “0”. Accordingly, in the fetched AND data “0x3e3fffff”, the 31 to 30 bits and the 24 and 21 bits are “0”.

The OR data is data for making the bit string corresponding to the instruction code the instruction which is selected at step S1212. Accordingly, the fetched OR data “0xc0000000” has an instruction format in which the 31 to 30 bits are “10” and the 24 and 21 bits are “0”.

The test controller multiplies the random number data 732 of “0x8abec860” with the AND data of “0x3e3fffff” (S1224). The multiplied generated data 734 is “0x0a9ec860”.

The test controller multiplies the data after an AND operation of “0x0a9ec860” with the OR data of “0xc0000000” (S1225). The multiplied generated data 736 is “0xca9ec860”.

As described above, the test controller generates an instruction code which is readable as an integer load instruction by the instruction decoder 170.

[5.2] Method of Generation of Operation Instruction not Complying with Test Protocols

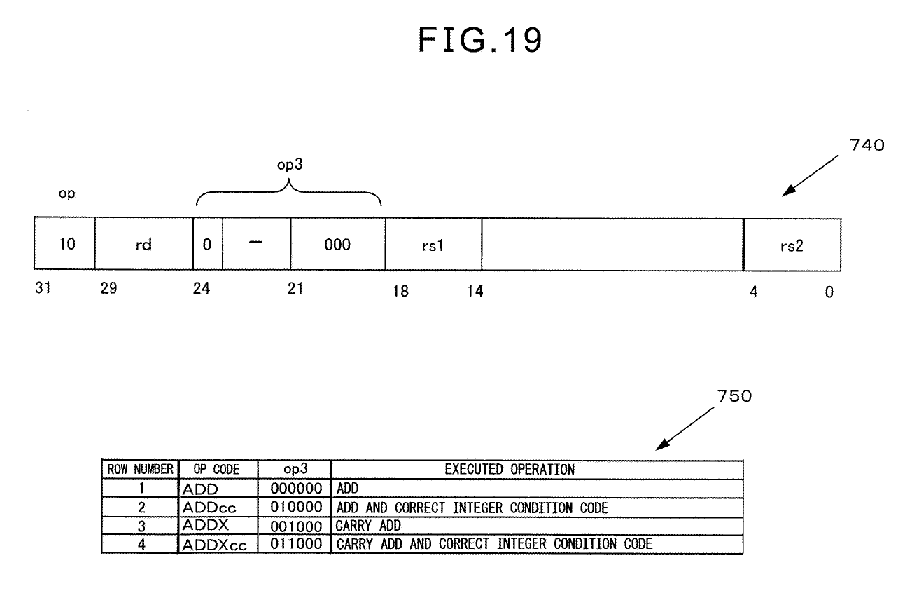

FIG. 19 is a view which illustrates one example of an operation instruction. The instruction format 740 which is illustrated in FIG. 19 is the instruction format of an addition instruction of one of the operation instructions of the SPARC® instruction set. Table 750 which is illustrated in FIG. 19 is a table which shows one example of addition instructions and executed operations.

In the instruction format 740 of the addition instruction, the 31 to 30 bits “op” and the 24 and 21 to 19 bits “0” specify the addition instruction. The 31 to 30 bits “op” and the 24 to 19 bits “op3” specify the opcode of the addition instruction. The “rs1” in the 18 to 14 bits field and the “rs2” in the 4 to 0 bits field indicate the address of the input register. The “rd” in the 29 to 25 bits field indicates the address of the output register.

Table 750, Row No. 1 explains the opcode “ADD” of the addition instruction. The “op3” of “000000” indicates “ADD”. “ADD” specifies the executed operation of adding the value at “rs2” to the value at “rs1” of the input register.

Table 750, Row No. 2, explains the opcode “ADDcc (Add and modify icc (integer condition code))” of the addition instruction. “op3” of “010000” indicates “ADDcc”. “ADDcc” specifies the operation of rewriting the integer condition code based on the results of the addition. The “integer condition code” is in the processor state register and is a condition code which is specified by bits. The condition code is used as a conditional branch instruction.

Table 750, Row No. 3, explains the opcode “ADDX” of the addition instruction. The “op3” of “000001” indicates “ADDX”. “ADDX” specifies the operation of carry addition.

Table 750, Row No. 4, explains the opcode “LDUH (LoaD Unsigned Halfword)” of the addition instruction. “op3” of “000010” indicates “LDUH”. “LDUH” specifies the operation of loading 2 bytes with no sign.

By specifying “op” and the 24 and 21 to 19 bits of “op3” by an AND operation and OR operation corresponding to the addition instruction and specifying the 22 to 19 bits of “op3” by random numbers, various addition instructions can be generated.

FIG. 20 is a view which illustrates one example of the instruction generation method of an operation instruction. Using FIG. 20, the flow for generation of an addition instruction from random number data will be explained along with the flow of generation of an instruction which is illustrated in FIG. 14. At step S1231 which is illustrated in FIG. 20, the processing system is used to generate the random number data 752. The random number data 752 is “0x8abec860”.

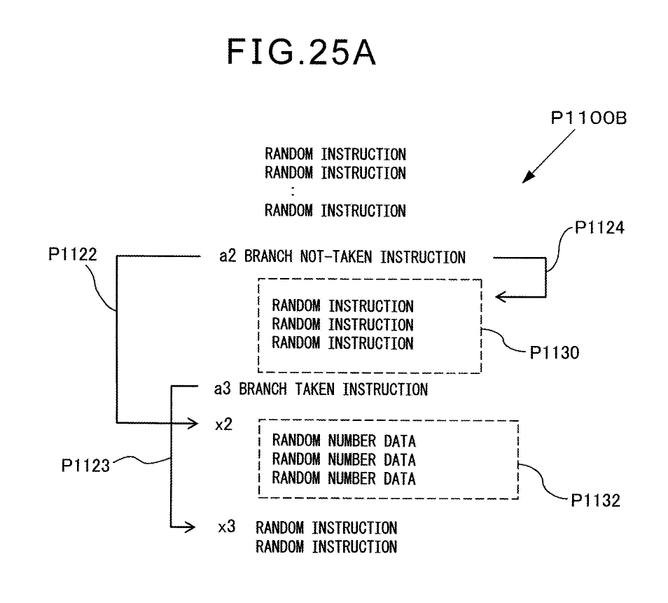

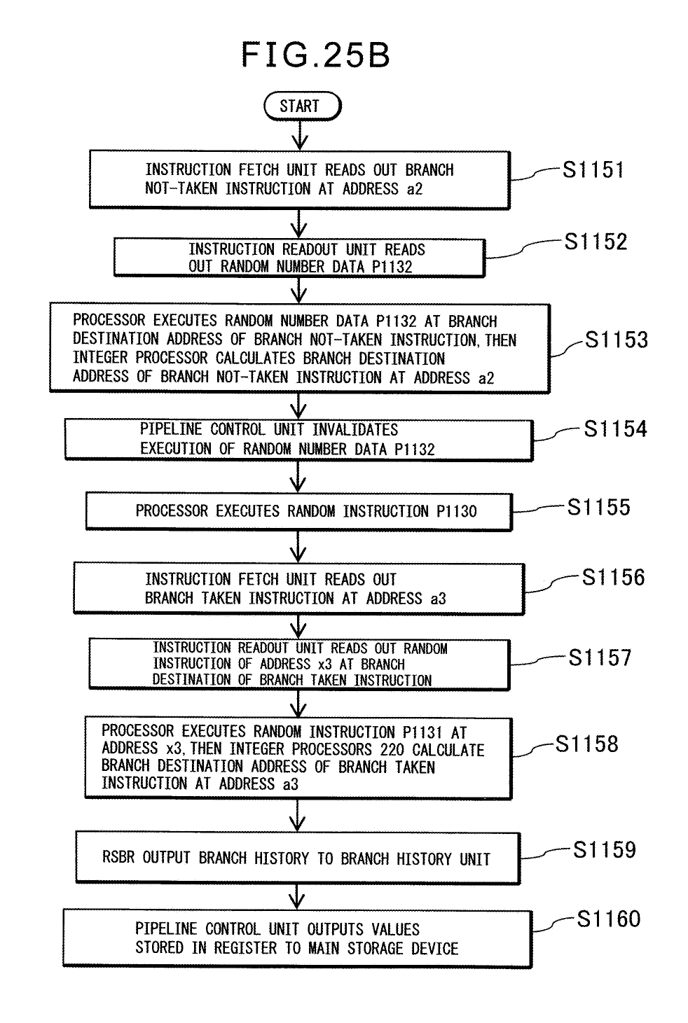

The test controller selects the instruction code which is to be generated (S1232). The selected instruction, in the example of FIG. 25, is an addition instruction. The processing system fetches the AND data and OR data which correspond to the selected instruction code from the instruction conversion table 930 (S1233). The fetched data is the AND data “0x3ec7ffff” and OR data “0x70000000” which correspond to the instruction code “addition instruction” which is shown in Row No. 605 of the instruction conversion table which is illustrated in FIG. 10A.

The AND data is data which makes the bit string which corresponds to the instruction code “0”. Accordingly, the fetched AND data “0x3ec7ffff” has the 31 to 30 bits and 21 to 19 bits made “0”.

The OR data is data which makes the bit string which corresponds to the instruction code the instruction which is selected at step S1232. Accordingly, the fetched OR data “0x70000000” has an instruction format in which the 31 to 30 bits are “10” and the 21 to 19 bits are “0”.

The test controller multiplies the random number data 752 “0x8abec860” with the AND data “0x3ec7ffff” (S1234). The multiplied generated data 754 is “0x0a86c860”.

The test controller multiples the data after the AND operation “0x8abec860” with the OR data “0x70000000” (S1235). The multiplied generated data 756 is “0x8a6cc860”.

In this way, the test controller generates an instruction code which is readable as the addition instruction by the instruction decoder 170.

[6] Operation for Execution of Test Program Containing Random Number Data not Following Test Protocols

FIG. 21A is a view which illustrates a first example of the order of execution of instructions of a test program. The test program P1000 includes a branch taken instruction at the address a1, a random instruction in advance of the address a1, random number data P1010 right after the address a1, and a random instruction at the address x1. The random instruction is an instruction which is generated in accordance with the above-mentioned test protocol. The branch taken instruction at the address a1 is an instruction by which a branch is taken. As a branch taken instruction includes, for example, an unconditional branch taken instruction by which a branch is taken unconditionally without referring to the condition code and a conditional branch taken instruction. When the unconditional branch taken instruction is generated, a branch is taken without regard to the condition code setting instruction which is generated in advance of the unconditional branch taken instruction. On the other hand, when the conditional branch instruction is generated, a condition code setting instruction which is generated in advance of the conditional branch instruction is generated so that the branch condition of the conditional branch instruction is established.

The random number data P1010 right after the address a1 is data which is generated by a random number. Since the random number data is data which is generated by a random number, it is unconstrained by the above-mentioned test protocols.

FIG. 21B is a view which illustrates a first example of processing of the processing system which executes the test program. Below, referring to FIG. 21A and FIG. 21B, processing for execution of the random number data by the processing system will be explained.

Assume that when executing the test program P1000, the branch history unit 130 does not have the execution history of the branch instruction. First, the instruction readout unit 120 reads out the instruction which is stored in the L1 instruction cache memory 110A to thereby read out the branch taken instruction at the address a1 (S1001). The read out instruction is a branch instruction, so the instruction readout unit 120 refers to the branch destination address of the branch instruction from the branch history unit 130, but the branch history is not present there, so the instruction readout unit 120 reads out the random number data P1010 right after the branch taken instruction (S1002). Note that, the processing at S1002 is illustrated by the arrow P1001 of FIG. 21A. In this way, the instruction readout unit 120 speculatively executes the instruction right after the branch instruction when the branch history unit 130 does not have the branch history.

The integer processor 220 calculates the branch destination address of the branch taken instruction and executes the random number data P1010 (S1003). The pipeline control unit 190 compares the branch destination address and the address of the random number data P1010 right after the branch taken instruction and, since the addresses differ, invalidates the execution of the random number data P1010 (S1004). The processor 210 executes the random instruction at the branch destination address (S1005). Note that, the processing at S1005 is explained by the arrow P1001 of FIG. 21A. The RSBR182 outputs the branch history to the branch history unit 130 (S1006). The pipeline control unit 190 outputs the values which are stored in the register to the main storage device (S1007).

The random number data is unconstrained by the test protocols, so if the execution units execute random number data, it may be possible that the memory other than the test space will be accessed or exception processing will occur and therefore execution of the test at the processing system will be obstructed. However, invalidation of the result of execution due to failure of speculative execution at step S1004 is erased from the entries of the CSE 250A and the reservation stations and other resources and is not stored in the register 250 or L1 cache memory 110 and is not utilized for execution of other instructions. For this reason, execution of random number data does not give rise to a state where the memory other than the test space is accessed or exception processing occurs. Further, execution of random number data does not give rise to a limitation on the address which is input to the register and does not give rise to a limitation on the input data or the register addressed which is used.

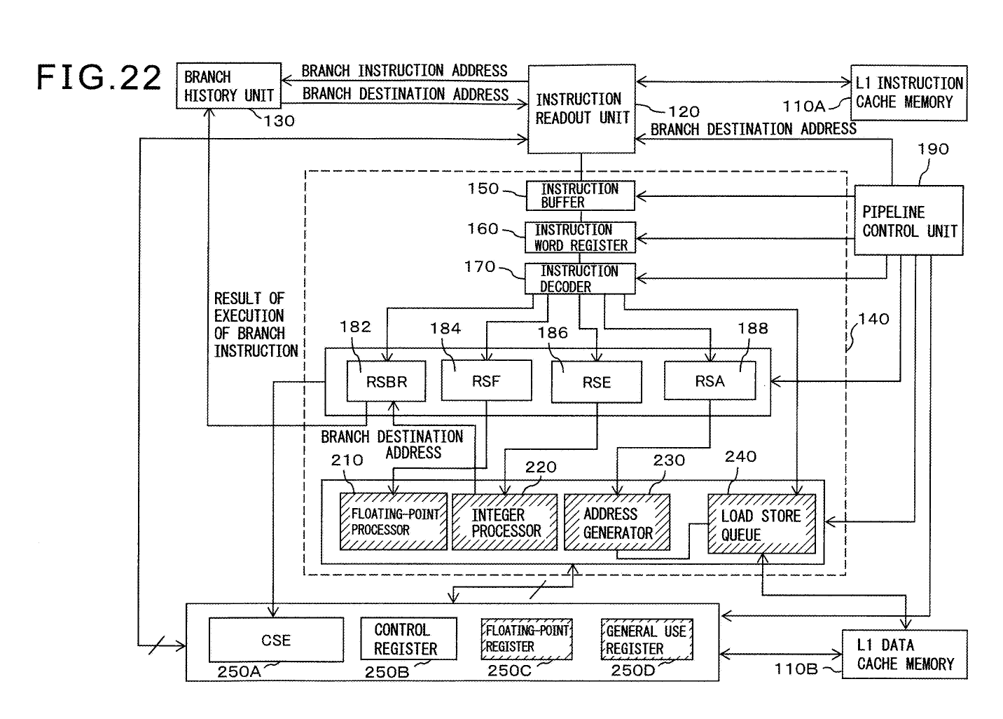

FIG. 22 is a view which illustrates one example of the processing system which operates by execution of the test program. In FIG. 22, the floating point processor 210, the integer processor 220, the address generator 230, the load/store queue 240, the floating point register 250C, and the general use register 250D are displayed by hatching. The components which are illustrated by hatching are verified in operation by allowing exception processing and not limiting use of the register addresses. For example, the floating point processor 210 and other execution units can perform exception processing and, further, register addresses not limited to the test memory area are used to verify executed operations which cannot be verified with tests complying with the test protocols.

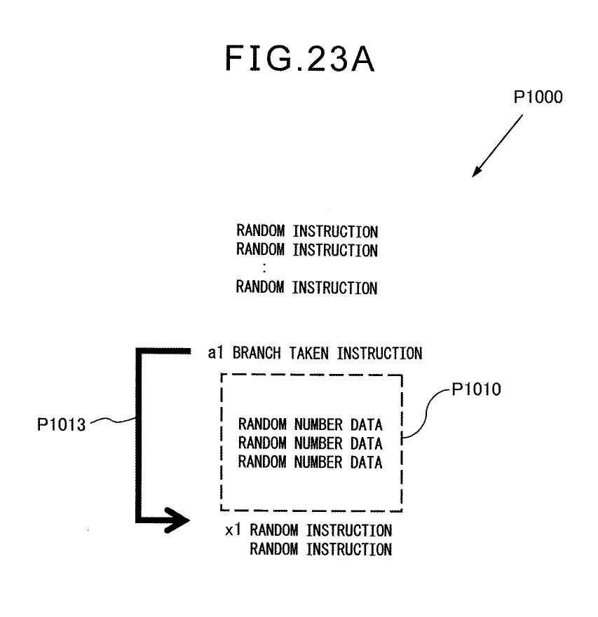

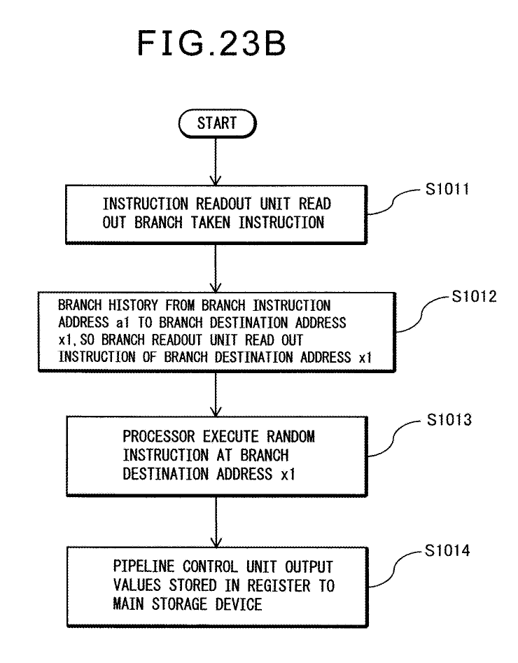

FIG. 23A is a view which illustrates a second example of processing for executing an instruction of a test program. The second example is an example of second execution of the test program which was executed by the processing system in FIG. 21A. The test program P1000 which is illustrated in FIG. 23A is the same as the test program P1000 which is illustrated in FIG. 21A, so explanation will be omitted.

FIG. 23B is a view which illustrates the second example of processing of the processing system which executes a test program. Below, referring to FIG. 23A and FIG. 23B, the processing for execution of random number data by the processing system will be explained.

When executing the test program P1000, the branch history unit 130 stores the fact that, by the execution of the test program which is illustrated in FIG. 21B, the branch destination address of the branch instruction at the address a1 is the address x1. The instruction readout unit 120 reads out the instruction which is stored in the L1 instruction cache memory 110A and reads out the branch taken instruction at the address a1 (S1011). The read out instruction is a branch instruction, so the instruction readout unit 120 refers to the branch destination address of the branch instruction from the branch history unit 130. There is the branch history from the address a1 of the branch instruction to the address x1 of the branch destination, so the instruction readout unit 120 reads out the instruction of the address x1 of the branch destination (S1012). The processor executes the random instruction at the address x1 of the branch destination (S1013). Note that, the processing at S1013 is explained by the arrow P1013 of FIG. 23A. The pipeline control unit 190 outputs the values which are stored in the register to the main storage device (S1014).

In the processing which is explained using FIG. 23A and FIG. 23B, the random number data P1010 is not executed. However, the processing other than execution of the random number data P1010 is the same as the first execution of the test program P1000 which was explained using FIG. 21A and FIG. 21B. For this reason, if comparison of the values of the register which are stored in the main storage device at step S1006 and the values of the register which are stored in the main storage device at step S1014 shows there is no difference between the two values, it can be judged that the processing system operates normally.

The execution of random number data is not reflected in the registers or main storage device due to invalidation of the results of speculative execution, so it is not simple to investigate the effects of execution of random number data. However, as explained above, by just executing the program of the test program P1000 two times, as illustrated in FIG. 22, it is possible to judge if the system is operating normally by having the execution units and registers etc. execute the random number data.

[5.2.2. Test Program Including Random Number Data at Branch Destination of Branch Instruction]

Below, an example of executing a test program which includes random number data at the branch destination of a branch instruction will be explained.

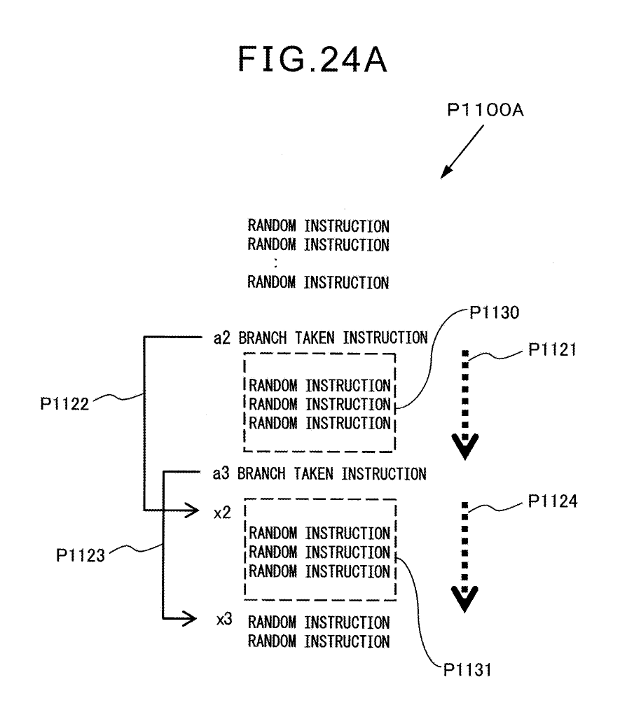

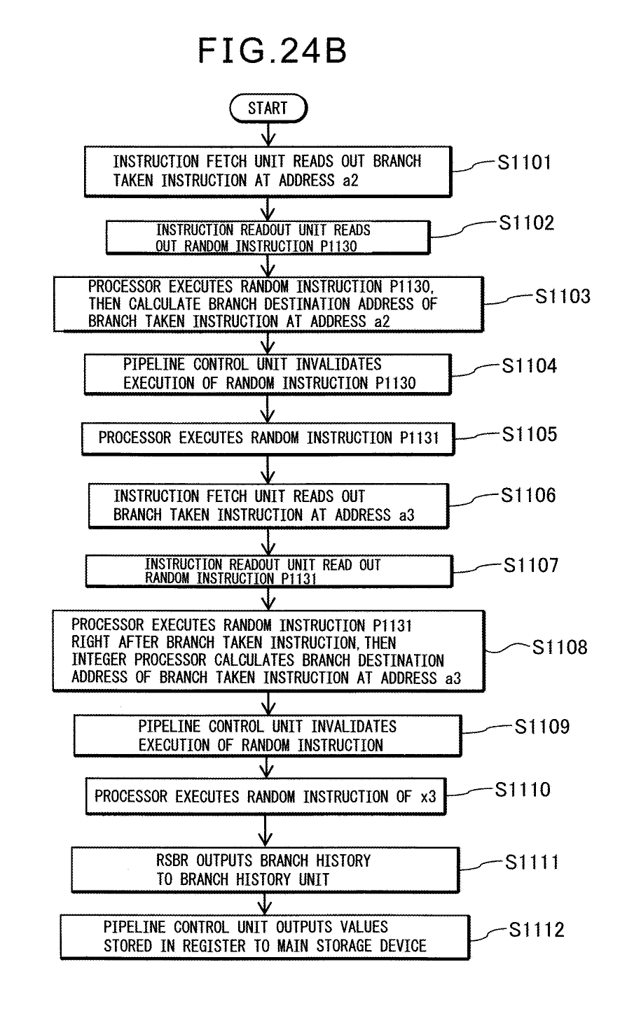

FIG. 24A is a view which illustrates a third example of the order of execution of instructions of the test program. FIG. 24B is a view which illustrates a third example of processing of the processing system which executes the test program. The test program P1100A includes branch taken instructions at the addresses a2 and a3, a random instruction before the address a2, a random instruction P1130 right after the address a2, a random instruction P1131 at the address x2, and a random instruction at the address x3. The branch destination of the branch taken instruction at the address a2, as shown by the arrow P1122, is the address x2. The branch destination of the branch taken instruction at the address a3, as shown by the arrow P1123, is the address x3. The test program P1100A does not contain random number data, but in the example which is illustrated in FIG. 24A and FIG. 24B, by execution of a branch instruction, the branch history remains. Note that, even if P1130 is executed speculatively as illustrated in FIG. 24A, the results of execution are not invalidated, so the random number data P1010 which is illustrated in FIG. 23A is also possible.

When executing the test program P1100A, in the initial state, it is deemed that the branch history unit 130 does not contain any history of execution of branch instructions. First, the instruction readout unit 120 reads out an instruction which is stored in the L1 instruction cache memory 110A to thereby read out the branch taken instruction at the address a2 (S1101). Since the branch history unit 130 does not contain any branch history, the instruction readout unit 120 reads out the random instruction P1130 right after the branch taken instruction (S1102). Note that, the processing at S1102 is explained by the arrow P1121 of FIG. 24A.

The processor executes the random instruction P1130 right after the branch taken instruction, then the integer processor 220 calculates the branch destination address of the branch taken instruction at the address a2 (S1103). The pipeline control unit 190 invalidates the execution of the random instruction P1130 since the branch destination address and the address of the random number data right after the branch taken instruction differ (S1104). The processor executes the random instruction P1131 at the address x2 of the branch destination of the branch taken instruction at the address a2 (S1105). Note that, the processing at S1105 is explained by the arrow P1124 of FIG. 24A. RSBR 182 outputs the branch history to the branch history unit 130 (S1105).

Next, the instruction readout unit 120 reads out the branch taken instruction at the address a3 (S1106). The branch history unit 130 does not contain the branch history for the branch instruction of the address a3, so the instruction readout unit 120 reads out the random instruction P1131 right after the branch taken instruction of the address a3 (S1107). Note that, the processing at S1107 is explained by the arrow P1124 of FIG. 24A.

The processor executes the random instruction P1131 right after the branch taken instruction, then the integer processor 220 calculates the branch destination address of the branch taken instruction at the address a3 (S1108). The pipeline control unit 190 compares the branch destination address of the calculated branch instruction and the address of the random number data right after the branch taken instruction at the address a3. In this example, the two differ, so the pipeline control unit 190 invalidates the execution of the random instruction (S1109). The processor executes the random instruction P1131 at the address x3 of branch destination which is the branch destination of the branch taken instruction of a3 (S1110). Note that, the processing at S1110 is explained by the arrow P1122 of FIG. 24A. RSBR182 outputs the branch history to the branch history unit 130 (S1111). Finally, the pipeline control unit 190 outputs the values which were stored in the register to the main storage device (S1112).

Note that, as explained above, the execution of the random instruction P1130 is invalidated. Further, the random instruction P1131 is executed two times at step S1105 and step S1108, but the second execution is invalidated at step S1109, so in execution of the test program P1100A, the random instruction P1131 is executed only one time. Accordingly, in execution of the test program P1100A, among the random instructions P1130 and P1131, the random instruction P1131 is executed one time.

FIG. 25A shows a fourth example of the sequence of execution of instructions of the test program. The test program P1100B which is shown in FIG. 25A is a test program obtained by changing part of the test program 1100A which is shown in FIG. 24A. The test program 1100B changes the branch taken instruction at the address a2 to a branch not-taken instruction. Note that, since the instruction of the address a2 becomes a branch not-taken instruction, in the test program P1100B which is shown in FIG. 25A, if the instruction right after the branch instruction at the address a2 is random number data, the random number data is changed to a random instruction. A “branch not-taken instruction” is an instruction by which a branch is not taken. A branch not-taken instruction includes, for example, an unconditional branch not-taken instruction where a branch is unconditionally not taken without referring to a condition code and a not-taken instruction of a conditional branch instruction. When an unconditional branch not-taken instruction is generated, no branch is established regardless of the condition code setting instruction which is generated in advance of the unconditional branch not-taken instruction, so there is no restriction on the generation of the condition code setting instruction. On the other hand, when a conditional branch instruction is generated as a branch not-taken instruction, the condition code setting instruction which is generated in advance of the conditional branch instruction is generated so that the branch condition of the conditional branch instruction is not taken.

FIG. 25B is a view which illustrates a fourth example of processing of a processing system which executes a test program. Below, referring to FIG. 25A and FIG. 25B, processing of the processing system for executing random number data will be explained.

When executing the test program P1100B, the branch history unit 130 has the branch history from the address a2 to the address x2 and the branch history from the address a3 to the address x3. First, the instruction readout unit 120 reads out an instruction which is stored in the L1 instruction cache memory 110A to thereby read out the branch not-taken instruction at the address a2 (S1151). Since the branch history unit 130 has the branch history from the address a2 to the address x2, the instruction readout unit 120 reads out the random number data P1132 at the address x2 (S1152). Note that, the processing at S1152 is explained by the arrow P1122 of FIG. 25A.

The processor executes the random number data P1132 at the branch destination address of the branch not-taken instruction, then the integer processor 220 calculates the branch destination address of the branch not-taken instruction at the address a2 (S1153). The pipeline control unit 190 invalidates the execution of the random number data P1132 since the address x2 of the calculated branch destination and the address of the random instruction right after the branch not-taken instruction differ (S1154). The processor executes the random instruction P1130 right after the branch not-taken instruction (S1155). Note that, the processing at S1155 is explained by the arrow P1124 of FIG. 25A.

After execution of P1130, the instruction readout unit 120 reads out the branch taken instruction at the address a3 (S1156). The branch history unit 130 has a branch history relating to the branch instruction of the address a3, so the instruction readout unit 120 reads out the random instruction of the address x3 at the branch destination of the branch taken instruction (S1157). Note that, the processing at S1157 is explained by the arrow P1123 of FIG. 25A.

The processor executes the random instruction P1131 at the address x3, then the integer processor 220 calculates the branch destination address of the branch taken instruction at the address a3 (S1158). RRBR182 outputs the branch history to the branch history unit 130 (S1159). Finally, the pipeline control unit 190 outputs the values which are stored in the register to the main storage device (S1160).

In the processing which is explained using FIG. 24A and FIG. 24B, the random number data is not executed. However, the processing for execution of a random instruction other than execution of random number data is similar to the execution of the test program P1100B which was explained using FIG. 25A and FIG. 25B in the point of executing the random instruction P1131 one time. For this reason, if a comparison of the values which are stored in the test space relating to the execution of the test program P1100A and the values which are stored in the test space relating to execution of the test program P1100B does not show a difference between the two values, it is possible to judge that the operation of the processing system is normal. Further, if a comparison of the values of the register which are stored in the main storage device at step S1112 and the values of the register which are stored in the main storage device at step S1160 does not show a difference between the two values, it is possible to judge that the operation of the processing system is normal.

By changing the type of the branch instruction in the test program or changing the arrangement of the program in this way, a test which executes a test program which includes random number data at the branch destination of a branch instruction becomes possible. For this reason, in the test program, the position of arrangement of the random number data is not limited to right after a branch instruction and may also be a branch destination.

FIG. 26 is a view which illustrates a modification of the number of instructions of the random number data. FIG. 26 illustrates the case of changing the number of instructions of the random number data P1010 which is illustrated in the test program P1000. The random number data P1010A of the test program P1000A which is illustrated in FIG. 26 is random number data increased in the number of random number data from the random number data P1010 which is illustrated in FIG. 21A by three. The random number data P1010B of the test program P1000B which is illustrated in FIG. 26 is random number data increased in the number of random number data from the random number data P1010A which is illustrated in FIG. 21A by nine. The execution of the <first> test program P1000 which is illustrated in FIG. 26 is the same as the execution of P1000 which is illustrated in FIG. 21A.

The test program P1000A is executed after the test program P1000 which is illustrated in FIG. 23A and FIG. 23B is executed two times, then the history of execution of the branch taken instruction of the address a1 in the branch history unit 130 is erased. That is, it is the test program which is used for the third test program execution test.

The test program P1000B is executed after the test program P1000A is executed, then the history of execution of the branch taken instruction of the address a1 in the branch history unit 130 is erased. That is, it is the test program which is used for the fourth test program run test.

Note that, while not illustrated in FIG. 26, after executing the program P1100A which is illustrated in FIG. 24A, by changing the number of instructions of the random number data P1132 which is illustrated in FIG. 25A so as to increase from the previously executed number of instructions, even a test program with random number data at the branch destination of the branch instruction can be used to execute a test differing in number of instructions of the random number data.

By changing the number of instructions of the random number data, the ratio of mixture of the actually not executed random number data and the actually executed random instructions is changed in the instruction string to be executed by speculative execution. Therefore, the number of instructions of the random number data which are cancelled due to failure of speculative execution changes, so it is possible to perform a test making a change in the timing of execution of instructions.

[7] Instruction String Including Random Number Data not Complying with Test Protocols

[7.1] Instruction String Including Branch Taken Instruction

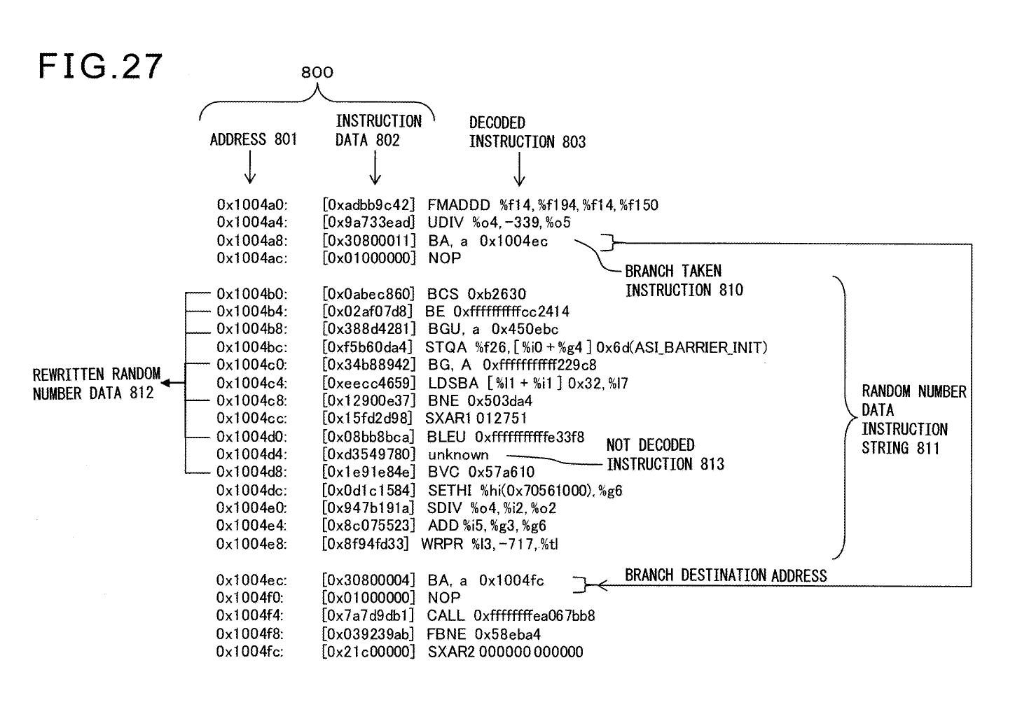

FIG. 27 is a view which illustrates one example of an instruction string which includes a branch taken instruction. 800 is one example of a test instruction strong which includes a branch taken instruction. The test instruction string 800 is an example which shows the test program P1000 which is illustrated in FIG. 21A by the instructions defined by the SPARC® instruction specifications.

The test instruction string 800 has the instruction data which is specified by the address 801. The decoded instruction 803 which is shown in FIG. 27 is an instruction which decoded the instruction data 802. The branch taken instruction 810 corresponds to the branch taken instruction at the address a1 at FIG. 21A. The random number data instruction string 811 corresponds to the random number data P1010 which is illustrated in FIG. 21A. In the random number data instruction string 811, the rewritten random number data 812 is an example of random number data which rewrites the instruction part of the random number data which was explained by FIG. 20 to FIG. 25 by an AND operation and OR operation.

The branch taken instruction 810 is the unconditional branch taken instruction “BA, a 0x1004ec”, which has the address “0x1004ec” as the branch destination address, at the address of “0x1004ac”.

The random number data instruction string 811 is generated as “15” instructions in number. Seven instructions in the random number data instruction string 811 are rewritten to predetermined instructions by an AND operation and OR operation so as to be readable by an instruction decoder. In the example which is illustrated in FIG. 27, the rewritten instructions are all branch instructions, that is, “BCS”, “BE”, “BGU”, “BNE”, “BLEU”, and “BVC” which are explained using Table 710 which is illustrated in FIG. 20.

Note that, in FIG. 27, 813 indicates an undecodable instruction. The instruction decoder 170 changes an instruction which cannot be decoded to “unknown” data. “Unknown” is the same as an “NOP (No Operation)” instruction. The execution unit does not execute any instruction if reading “unknown”. However, if an “unknown” instruction is generated, the program counter and the instruction counter are incremented by “1”. By rewriting to the predetermined instructions by an AND operation and OR operation so as to become readable by the instruction decoder, the “unknown” data is reduced.

[7.2] Instruction String Including Branch Not-Taken Instruction

FIG. 28 is a view which illustrates one example of an instruction string which includes a branch not-taken instruction. 850 is one example of a test instruction string which includes a branch taken instruction. The test instruction string 850 is an example which illustrates the test program P1100B which is illustrated in FIG. 25A by the instructions which are prescribed in the SPARC® instruction specifications.

The test instruction string 850 has instruction data 852 which is specified by the address 851. The decoded instruction 853 which is illustrated in FIG. 28 is an instruction which decoded the instruction data 852. The branch not-taken instruction 860 corresponds to a branch not-taken instruction at the address a2 of FIG. 25A. The random instruction string 861 corresponds to the random instruction P1131 of FIG. 25A. The branch taken instruction 862 corresponds to the branch taken instruction at the address a3 of FIG. 25A. The branch not-taken instruction 860 is an unconditional branch not-taken instruction “BE”.

In the random number data instruction string 863, the rewritten random number data 864 is an example of random number data obtained by rewriting the instruction part of the random number data which was explained at FIG. 20 to FIG. 25 by an AND operation and OR operation.

The random number data instructions are generated as “5” instructions in number. Five instructions in the random number data instruction string 863 are rewritten to predetermined instructions by an AND operation and OR operation so that the instruction decoder can decipher them. In the example which is illustrated in FIG. 28, the rewritten generated instructions are all branch instructions, that is, “BL”, “BVC”, “BCS”, and “BA”.

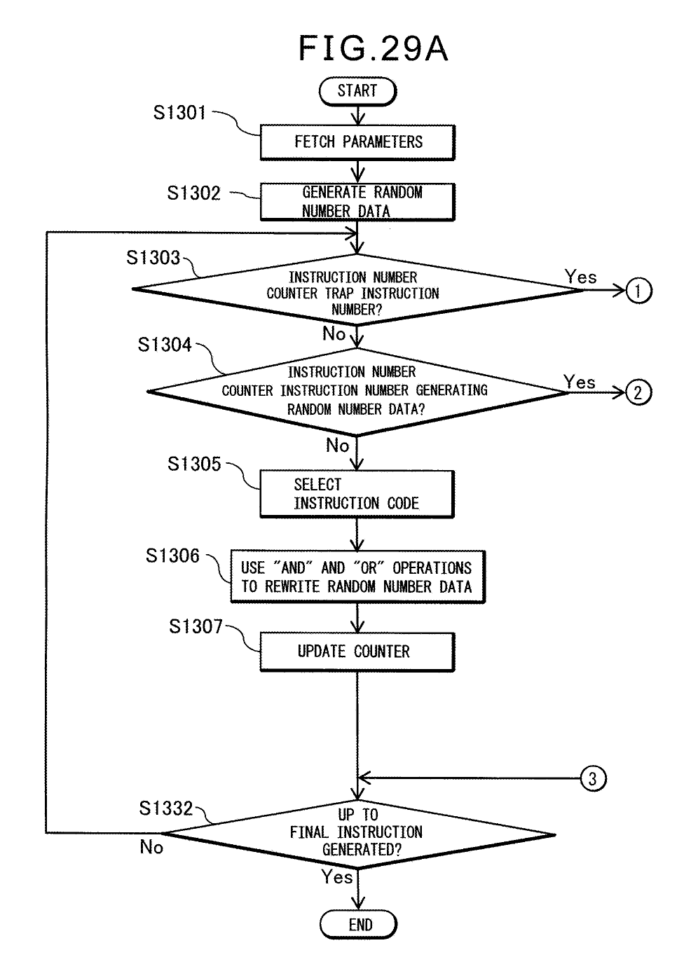

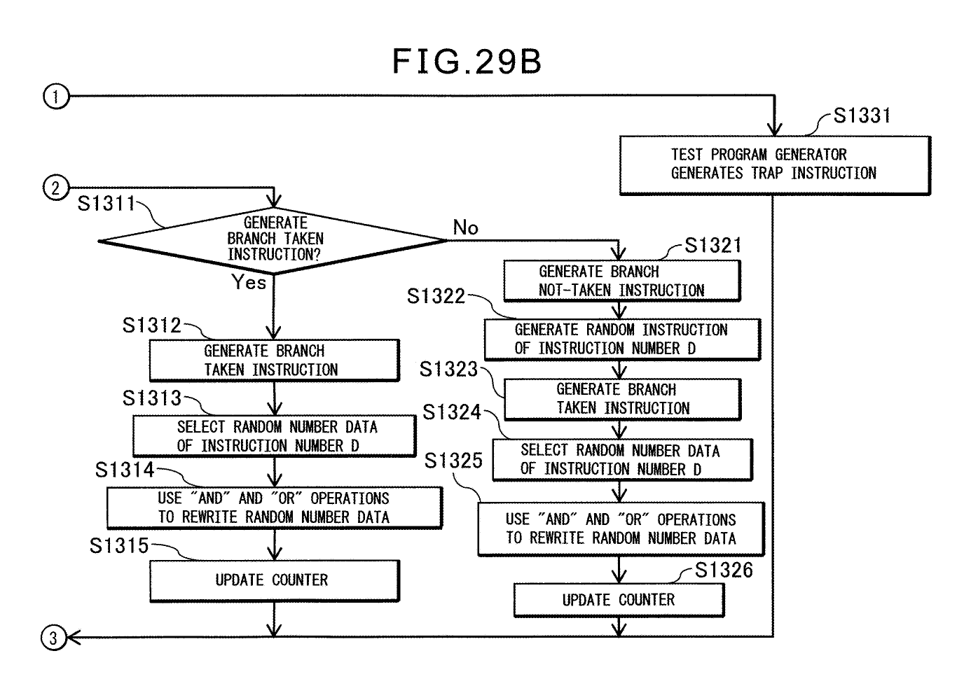

Next, referring to FIG. 29 to FIG. 31, the processing for generating the test program and the processing for executing the test program will be explained.

[8] Flow of Processing for Generating Test Program

The test program generator executes the test program generation program 910 to generate the test program 920 in the storage area of the main storage device 520.

FIG. 29A and FIG. 29B are views which illustrate one example of the processing for generating the test program. The test program generator fetches the parameters from the parameter table 940 (S1301). The test program generator generates random number data (S1302). The test program generator uses the seed value S of the parameter table 940 to generate random number data and writes the random number data in the storage area of the main storage device 520 which stores the test program. The test program generator judges whether the instruction count is a number for generating a trap instruction (S1303). The instruction count is integer data which indicates the number of generated instructions. The instruction count is stored in the control register 250B which is illustrated in FIG. 4 or another register. Further, the judgment of whether the instruction count is a number for generating a trap instruction determines if the number of instructions from the previously generated trap instruction is the interval C for generating trap instructions of the parameter table 940, that is, “512”.

When the instruction count is a number for generating a trap instruction (S1303 Yes), the test program generator generates a trap instruction (S1331) and, further, executes step S1332. When the instruction counter is not a number for generating a trap instruction (S1303 No), the test program generator judges if the instruction counter is a number of instructions for generating random number data (S1304). The judgment of whether the instruction counter is a number of instructions for generating random number data judges if the number of instructions from the branch instruction immediately before the previously generated random number data has reached the random number data generation interval R.

[8.1] Generation of Random Instruction

When the instruction counter is not a number of instructions for generating random number data (S1304 No), the test program generator selects an instruction code of any generated instruction from the instruction conversion table 930 (S1305). The test program generator fetches AND data and OR data which correspond to the instruction code which was selected from the instruction conversion table 930 and uses the fetched AND data and OR data to rewrite the random number data which was written in the processing device 510 (S1306). Due to the rewrite at step S1305, as explained using FIG. 1 to FIG. 3, a random instruction complying with test protocols is generated. The test program generator updates the counter (S1307). By the processing to update the counter of S1307, the number of instructions to be added to the counter becomes the number of instructions which were generated at S1305 to S1306, for example, “1”. If updating the counter, the test program generator executes step S1332.

[8.2] Generation of Branch Taken Instruction String

When the instruction counter indicates a count of instructions for generating random number data (S1304 Yes), the test program generator judges whether to generate an instruction string for branch taking use (S1311). If generating an instruction string for branch taking use, there is the branch taken instruction at the address a1 of the test program P1000 which is illustrated in FIG. 21A, the branch taken instructions at the addresses a2 and a3 of the test program P1100A which is illustrated at FIG. 24A, etc.

If the test program generator judges to generate an instruction string for branch taking use (S1311 Yes), the test program generator generates a branch taken instruction (S1312). The generated branch taken instruction is, for example, the branch taken instruction 810 which is illustrated in FIG. 27.

The test program generator selects the random number data of the number of instructions D from the random number data which is stored at the main storage device 520 (S1313). The random number data of the number of instructions D which was selected at step S1313 is, for example, the random number data instruction string 811 which is illustrated in FIG. 27.

The test program generator rewrites the random number data of the D number of instructions selected by AND and OR operation (S1314). The random number data which was rewritten at step S1314 is, for example, the rewritten random number data 812 which is illustrated at FIG. 27.

The test program generator updates the instruction counter (S1315). Due to the instruction counter update processing of S1315, the number of instructions which is added to the instruction counter is the number of instructions which were generated at S1312 and S1313. For example, it is the sum of the number of instructions “1” of the branch taken instruction and the number of instructions “3” of the random number data D incremented further by “1”. If updating the counter, the test program generator executes step S1332.

[8.3] Generation of Branch Not-Taken Instruction String

When the instruction counter indicates a number of instructions for generating random number data (S1304 Yes), the test program generator judges whether to generate an instruction string for branch taking use (S1311). An example not an instruction string for branch taking use, that is, an example of an instruction string for branch not taking use, is the branch not-taken instruction at the address a2 of the test program P1100B of FIG. 25A. For example, this is the case where, if generating the test program P1100B of FIG. 25A, the test program P1100A has already been executed one time by the test controller. In that case, the test program generator refers to the number of times tests were executed etc. in the test log data 960, judges if the test program being generated is the test program P1100B which is to be executed after the test program P1100A, and judges to generate the branch not-taken instruction at step S1311.

If the test program generator judges to generate an instruction string for branch not taking use (S1311 No), the test program generator generates a branch not-taken instruction (S1321). The generated branch not-taken instruction is, for example, the branch not-taken instruction 860 which is illustrated in FIG. 28.

The test program generator generates random instructions of the number of instructions D (S1322). The generated random instructions of the number of instructions D are, for example, the random instruction string 861 which is illustrated in FIG. 28. The test program generator generates a branch taken instruction (S1323). The generated branch taken instruction is, for example, a branch taken instruction 862 which is illustrated in FIG. 28.

The test program generator selects random number instructions of the number of instructions D (S1324). At step S1324, the selected random number instructions of the number of instructions D are, for example, the random number data instruction string 863 which is illustrated in FIG. 28. The test program generator rewrites the random number data of the selected D instructions by AND and OR operations (S1325). The rewritten random number data at step S1325 is, for example, the rewritten random number data 864 which is illustrated in FIG. 28.

The test program generator updates the instruction counter (S1326). Due to the instruction counter update processing of S1326, the number of instructions which are added to instruction counter is the number of instructions which are generated at S1321 to S1324, that is, the sum of the number of instructions 1 of the branch taken instruction, the number of instructions D of the random instructions, the number of instructions 1 of the branch taken instruction, and the number of instructions D of the random number data instructions further incremented by “1”. If updating the instruction counter, the test program generator executes step S1332.

The test program generator judges whether the test program has been generated up to the final instruction (S1332). Step S1332 enables the test program generator to judge if the counter has become the number N of generation of instructions.

When not generated up to the final instruction (S1332 No), the test program generator reexecutes step S1303. When generated up to the final instruction (S1332 Yes), the test program generator ends the test program generation processing.

[9] Flow of Processing for Execution of Test Program

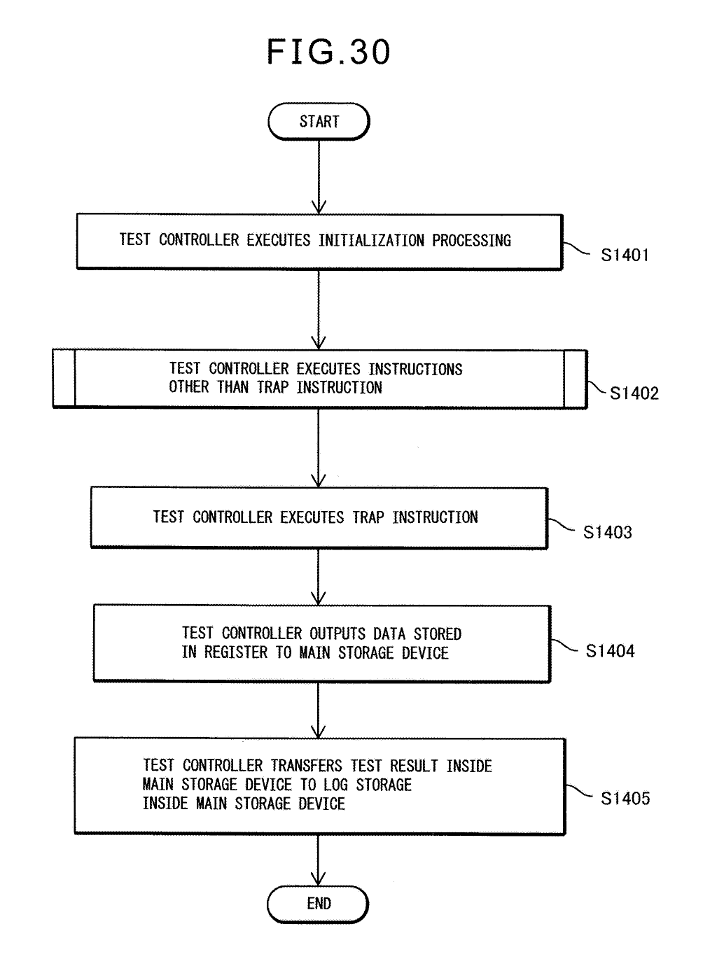

FIG. 30 is a view which illustrates one example of processing for execution of a test program. The test controller executes the test program 920 to start the processing for execution of the test program. The test controller performs processing for initialization (S1401). The “initialization processing”, as explained using FIG. 10, for example, stores normalized data in the general use register 250D. This is to enable execution of random instructions in the test program.

The test controller executes instructions other than the trap instruction (S1402). “Execution of instructions other than the trap instruction” corresponds to, for example, execution of the test program which is illustrated in FIG. 23B, FIG. 24B, FIG. 25B, and FIG. 26.

The test controller executes a trap instruction (S1403). If executing the trap instruction, the test controller outputs the data which is stored in the register 250 to the log storage area of the main storage device 520 (S1404). The test controller further transfers the test results 950 in the main storage device 520 to the log storage area inside of the main storage device (S1405). The test controller executes the processing of S1402 to S1405 until the last instruction of the test program and ends the processing for execution of the test program.

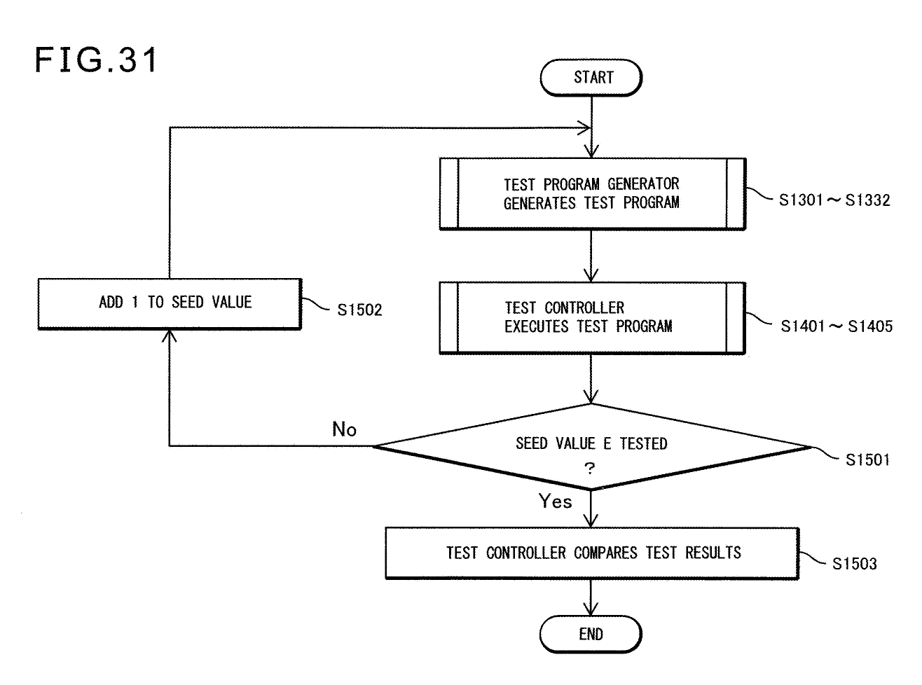

FIG. 31 is a view which illustrates one example of processing for generation and processing for execution of a test program. The test program generator generates a test program (S1301 to S1332). Steps S1301 to S1332 are processing which were explained using FIG. 29A and FIG. 29B. The test controller executes the test program (S1401 to S1405). Steps S1401 to S1405 are processing which were explained using FIG. 30. The test program generator judges whether the seed value E was tested (S1501). The “seed value E” is the seed value which is used for generation of the end random number. When the seed value E is not tested (S1501 No), the test program generator adds “1” to the current seed value (S1502) and reexecutes steps S1301 to S1332. When the seed value E is tested (S1501 Yes), the test controller executes processing for comparison of the test results which are stored in the test log data 960 of the main storage device (S1503) and ends the processing for generation and processing for execution of the test program. The comparison processing is a comparison of the test results which were generated by execution of the same test instruction string, for example, the test results due to execution of the test program P1000 which is illustrated in FIG. 21A and the test results due to execution of the test program P1000 which is illustrated in FIG. 23A. These test results inherently become the same since the results of execution of the random number data are invalidated. If there is a difference, there is an abnormality in the operation of the processing system due to execution of the random number data, so it is learned that there is an issue in the normal operation of the processing system.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A test method comprising:
reading out, by a processor, a branch instruction from a storage unit that stores instructions;
referring to a branch destination address of the branch instruction in a branch history unit that stores a branch history which links an address of the branch instruction and a branch destination address;
reading out first random number data unconstrained by test protocols as the succeeding instruction of the branch instruction from the storage unit when the branch history of the branch instruction is not stored in the branch history unit;
calculating the branch destination address of the branch instruction and executing the first random number data; and
invalidating the result of execution of the first random number data when the calculated branch destination address and the address of the random number data differ.

2. The test method according to claim 1, further comprising;
reading out second random number data at the branch destination address linked in the branch history of the branch instruction from the storage unit when the branch history of the branch instruction is stored in the branch history unit;
executing the second random number data; and
invalidating the result of execution of the second random number data when the calculated branch destination address and the address of the second random number data differ.

3. The test method according to claim 1, wherein the number of the random number data is changed when the test method is repeated.

4. The test method according to claim 1, wherein the random number data includes an instruction code.

5. A processing device comprising:
a storage unit that stores a branch instruction and random number data unconstrained by test protocols;
a branch history unit that stores a branch history which links an address of the branch instruction and a branch destination address of the branch instruction;
an instruction readout unit that reads out the instruction from the storage unit;
a processor that calculates the destination address of the branch instruction and executes the instruction that are read out by the instruction readout unit; and
a branch control unit that instructs the instruction readout unit to read out first random number data unconstrained by test protocols as the succeeding instruction of the branch instruction when the branch history of the branch instruction is not stored in the branch history unit, and invalidates the result of execution of the first random number data by the processor when the branch destination address of the branch instruction calculated by the processor and the address of the random number data differ.

6. The processing device according to claim 5, wherein the instruction readout unit reads out second random number data at a branch destination address linked in the branch history of the branch instruction from the storage unit when the branch history of the branch instruction is stored in the branch history unit,
the processor executes the second random number data, and
the branch control unit invalidates the result of execution of the second random number data when the calculated branch destination address and the address of the second random number data differ.

7. The processing device according to claim 5, wherein the number of the random number data is changed when the test method is repeated.

8. The processing device according to claim 5 wherein the random number data includes an instruction code.

9. A computer-readable medium having stored therein a test program that causes a computer to execute a test method, the test method comprising:
reading out a branch instruction from a storage unit;
referring to a branch destination address of the branch instruction in a branch history unit that stores a branch history which links an address of the branch instruction and a branch destination address;
reading out first random number data unconstrained by test protocols as a succeeding instruction of the branch instruction when a branch history of the branch instruction is not stored in a branch history unit;
calculating a branch destination address of the branch instruction and executing the first random number data; and
invalidating the result of execution of the first random number data when the calculated branch destination address and the address of the first random number data differ.

10. The computer-readable medium according to claim 9, wherein the test method further comprising;
reading out second random data at a branch destination address linked with the branch instruction in the branch history of the branch instruction from the storage unit when the branch history of the branch instruction is stored in the branch history unit;
executing the second random number data; and
invalidating the result of execution of the second random number data when the calculated branch destination address and the address of the second random number data differ.

11. The computer-readable medium according to claim 9, wherein the number of the random number data is changed when the test method is repeated.

12. The computer-readable medium according to claim 9, wherein the random number data includes an instruction code.

13. A test program generation method comprising:
generating, by a processor, a branch instruction to be taken;
storing the branch instruction in a main storage device;
generating first random number data;
storing the first random number data as a succeeding instruction of the branch instruction in the main storage device;
generating an instruction; and
storing the instruction at a branch destination of the branch instruction in the main storage device.

14. The test program generation method according to claim 13, further comprising:
changing the branch instruction to be taken to a branch instruction to be not taken;
changing the random number data to an instruction different from random number data;
generating second random number data; and
storing the second random number data at the branch destination of the branch instruction.

15. The test program generation method according to claim 13, wherein the random number data includes an instruction code.

16. A test program generator comprising:
a main storage device; and
a processing device that generates a branch instruction to be taken and stores the branch instruction in the main storage device, generates random number data and stores the random number data as a succeeding instruction of the branch instruction in the main storage device, and generates an instruction and stores the instruction in the main storage device at a branch destination of the branch instruction.

17. The test program generator according to claim 16, wherein the processing device changes the branch instruction to be taken to a branch instruction to be not taken, changes the random number data to an instruction different from random number data, generates second random number data, and stores the second random number data at the branch destination of the branch instruction.

18. The test program generator according to claim 16, wherein the random number data includes an instruction code.

19. A computer-readable medium having stored a computer program that causes a computer to execute a test program generation method, the test program generation method comprising:
generating a branch instruction to be taken;
storing the branch instruction in a main storage device;
generating first random number data;
storing the first random number data as a succeeding instruction of the branch instruction in the main storage device;
generating an instruction; and
storing the instruction in the main storage device at a branch destination of the branch instruction.

20. The computer-readable medium according to claim 19, the test program generation method further comprising:
changing the branch instruction to be taken to a branch instruction to be not taken;
changing the random number data to an instruction different from random number data;
generating second random number data; and
storing the second random number data at the branch destination of the branch instruction in the main storage device.
